(19) United States
(12) Patent Application Publication
(10) Pub. No.: US 2026/0245312 A1
(43) Pub. Date: Aug. 20, 2026

(54) MAINTAINING VISUAL CONSISTENCY OF VISUAL REPRESENTATIONS OF REMOTE USERS IN THREE-DIMENSIONAL ENVIRONMENTS WITHIN MULTI-USER COMMUNICATION SESSIONS

(71) Applicant: Apple Inc., Cupertino, CA (US)

(72) Inventors: Gabrielle ECANOW, Santa Clara, CA (US); Jiwoo JANG, San Francisco, CA (US); Tommy ROCHETTE, Santa Cruz, CA (US); Connor A. SMITH, San Jose, CA (US); Kevin LEE, San Jose, CA (US); Shih-Sang CHIU, San Francisco, CA (US); Joseph P. CERRA, San Francisco, CA (US)

(21) Appl. No.: 19/461,638

(22) Filed: Jan. 27, 2026

Related U.S. Application Data
(60) Provisional application No. 63/760,002, filed on Feb. 18, 2025.

(51) Int. Cl. G06T 19/00; H04L 65/1089

(52) U.S. Cl. CPC G06T 19/00; H04L 65/1089; G06T 2219/024

(57) ABSTRACT

Some examples of the disclosure are directed to systems and methods for maintaining visual consistency of a visual representation of one or more remote users in a three-dimensional environment within a multi-user communication session that includes a group of collocated users. Some examples of the disclosure are directed to systems and methods for transitioning display of a visual representation of a remote user from a virtual tile to a three-dimensional avatar in a three-dimensional environment within a multi-user communication session that includes a group of collocated users.

### CROSS-REFERENCE TO RELATED APPLICATIONS

This application claims the benefit of U.S. Provisional Application No. 63/760,002, filed Feb. 18, 2025, the content of which is herein incorporated by reference in its entirety for all purposes.

### FIELD OF THE DISCLOSURE

This relates generally to systems and methods of managing visual representations of users in multi-user communication sessions in which at least a subset of participants within the multi-user communication sessions is collocated in a physical environment.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for maintaining visual consistency of a visual representation of one or more remote users in a three-dimensional environment within a multi-user communication session that includes a group of collocated users. In some examples, a method is performed at a first electronic device in communication with one or more displays and one or more input devices, wherein the first electronic device is collocated with a second electronic device in a physical environment. In some examples, while in a multi-user communication session with the second electronic device and a plurality of respective electronic devices, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data. In some examples, while presenting the plurality of virtual representations of the plurality of users of the plurality of respective electronic devices in the three-dimensional environment, the first electronic device detects a change or an update in the first prioritization data. In some examples, in response to detecting the change in the first prioritization data, in accordance with a determination that the first prioritization data satisfies one or more criteria based on the change in the first prioritization data, the first electronic device updates presentation, via the one or more displays, of the plurality of virtual representations to have a second spatial arrangement, different from the first spatial arrangement, and transmits, to the second electronic device, respective display data that causes the second electronic device to update presentation, via one or more second displays of the second electronic device, of the plurality of virtual representations to have the second spatial arrangement. In some examples, in accordance with a determination that the first prioritization data fails to satisfy the one or more criteria based on the change in the first prioritization data, the first electronic device maintains presentation of the plurality of virtual representations having the first spatial arrangement in the three-dimensional environment, and forgoes transmitting, to the second electronic device, the respective display data.

Some examples of the disclosure are directed to systems and methods for transitioning display of a visual representation of a remote user from a virtual canvas to a three-dimensional avatar in a three-dimensional environment within a multi-user communication session that includes a group of collocated users. In some examples, a method is performed at a first electronic device in communication with one or more displays and one or more input devices, wherein the first electronic device is collocated with a second electronic device in a physical environment. In some examples, while in a multi-user communication session with the second electronic device and a plurality of respective electronic devices including a third electronic device, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device. In some examples, while presenting the plurality of virtual representations of the plurality of users of the plurality of respective electronic devices in the three-dimensional environment, the first electronic device detects an indication of input received at the third electronic device of the plurality of respective electronic devices corresponding to a request to represent a user of the third electronic device as a three-dimensional representation, different from a first virtual representation of the user of the third electronic device, in the three-dimensional environment, wherein the first virtual representation of the user of the third electronic device occupies a first position within the first spatial arrangement. In some examples, in response to detecting the indication of the input, the first electronic device ceases presentation, via the one or more displays, of the first virtual representation of the plurality of virtual representations in the three-dimensional environment. In some examples, the first electronic device presents, via the one or more displays, a three-dimensional representation of the user of the third electronic device at a placement location that is relative to the plurality of virtual representations in the three-dimensional environment, wherein the placement location in the three-dimensional environment is based on the first position of the first virtual representation within the first spatial arrangement.

The full descriptions of these examples are provided in the Drawings and the Detailed Description, and it is understood that this Summary does not limit the scope of the disclosure in any way

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4J illustrate examples of maintaining visual consistency of a visual representation of a remote user in a three-dimensional environment within a multi-user communication session that includes collocated and non-collocated users according to some examples of the disclosure.

FIGS. 5A-5K illustrate examples of transitioning display of a visual representation of a remote user from a virtual canvas to a three-dimensional avatar in a three-dimensional environment within a multi-user communication session that includes collocated and non-collocated users according to some examples of the disclosure.

FIG. 6 is a flow diagram illustrating an example process for maintaining visual consistency of a visual representation of a remote user in a three-dimensional environment within a multi-user communication session according to some examples of the disclosure.

FIG. 7 is a flow diagram illustrating an example process for transitioning display of a visual representation of a remote user from a virtual canvas to a three-dimensional avatar in a three-dimensional environment within a multi-user communication session according to some examples of the disclosure.

### DETAILED DESCRIPTION

Some examples of the disclosure are directed to systems and methods for maintaining visual consistency of a visual representation of a remote user in a three-dimensional environment within a multi-user communication session that includes a group of collocated users. In some examples, a method is performed at a first electronic device in communication with one or more displays and one or more input devices, wherein the first electronic device is collocated with a second electronic device in a physical environment. In some examples, while in a multi-user communication session with the second electronic device and a plurality of respective electronic devices, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data. In some examples, while presenting the plurality of virtual representations of the plurality of users of the plurality of respective electronic devices in the three-dimensional environment, the first electronic device detects a change or an update in the first prioritization data. In some examples, in response to detecting the change in the first prioritization data, in accordance with a determination that the first prioritization data satisfies one or more criteria based on the change in the first prioritization data, the first electronic device updates presentation, via the one or more displays, of the plurality of virtual representations to have a second spatial arrangement, different from the first spatial arrangement, and transmits, to the second electronic device, respective display data that causes the second electronic device to update presentation, via one or more second displays of the second electronic device, of the plurality of virtual representations to have the second spatial arrangement. In some examples, in accordance with a determination that the first prioritization data fails to satisfy the one or more criteria based on the change in the first prioritization data, the first electronic device maintains presentation of the plurality of virtual representations having the first spatial arrangement in the three-dimensional environment, and forgoes transmitting, to the second electronic device, the respective display data.

Some examples of the disclosure are directed to systems and methods for transitioning display of a visual representation of a remote user from a virtual tile to a three-dimensional avatar in a three-dimensional environment within a multi-user communication session that includes a group of collocated users. In some examples, a method is performed at a first electronic device in communication with one or more displays and one or more input devices, wherein the first electronic device is collocated with a second electronic device in a physical environment. In some examples, while in a multi-user communication session with the second electronic device and a plurality of respective electronic devices including a third electronic device, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device. In some examples, while presenting the plurality of virtual representations of the plurality of users of the plurality of respective electronic devices in the three-dimensional environment, the first electronic device detects an indication of input received at the third electronic device of the plurality of respective electronic devices corresponding to a request to represent a user of the third electronic device as a three-dimensional representation, different from a first virtual representation of the user of the third electronic device, in the three-dimensional environment, wherein the first virtual representation of the user of the third electronic device occupies a first position within the first spatial arrangement. In some examples, in response to detecting the indication of the input, the first electronic device ceases presentation, via the one or more displays, of the first virtual representation of the plurality of virtual representations in the three-dimensional environment. In some examples, the first electronic device presents, via the one or more displays, a three-dimensional representation of the user of the third electronic device at a placement location that is relative to the plurality of virtual representations in the three-dimensional environment, wherein the placement location in the three-dimensional environment is based on the first position of the first virtual representation within the first spatial arrangement.

In some examples, a spatial group or state in the multi-user communication session denotes a spatial arrangement or template that dictates locations of users and content that are located in or otherwise associated with the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

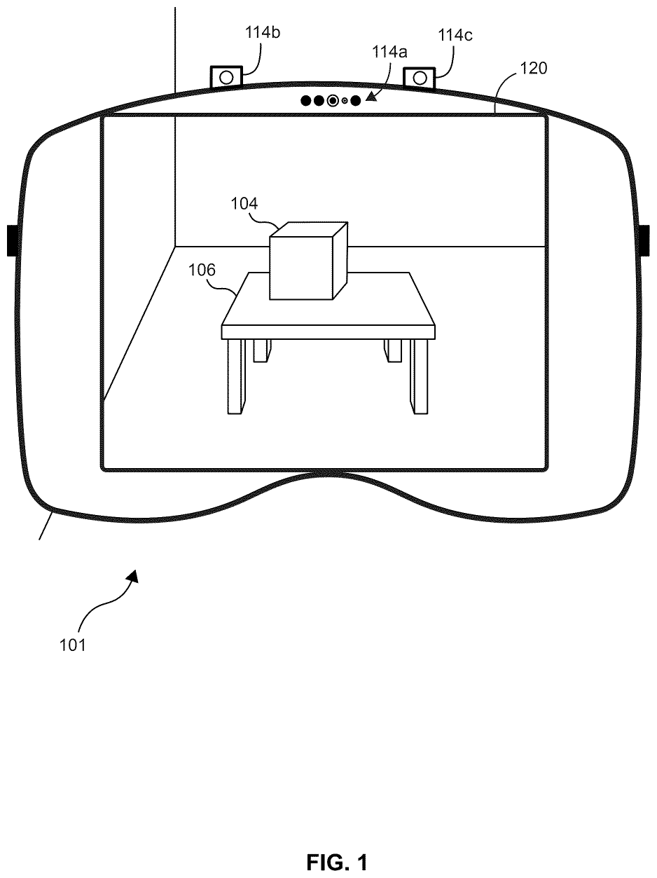

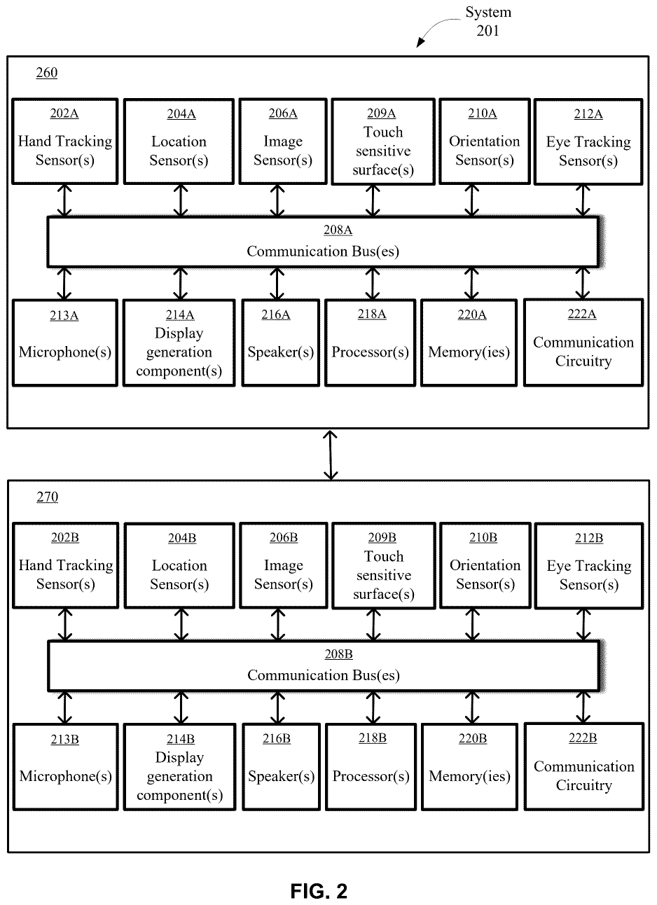

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of table 106 (real-world table or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second electronic device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

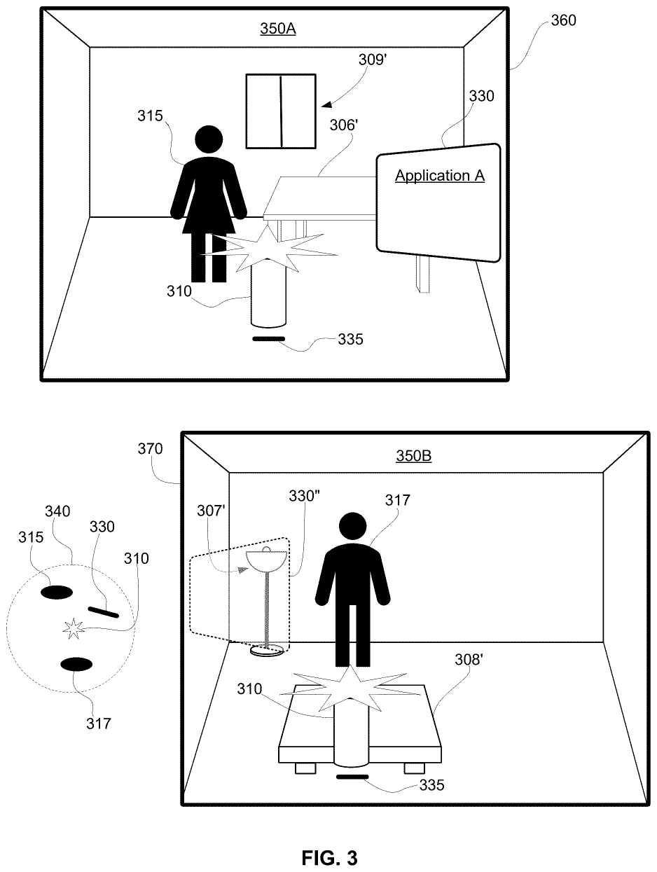

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for, while facilitating a multi-user communication session that includes collocated and non-collocated users (e.g., collocated and non-collocated electronic devices associated with the users), maintaining visual and/or spatial consistency of visual representations of the non-collocated users in the multi-user communication session. For example, it may be desirable to enable users who are collocated in a first physical environment to visually see visual representations of remote users at the same locations in a three-dimensional environment for improved and/or increased interaction with the visual representations in the three-dimensional environment while in the multi-user communication session. As used herein, relative to a first electronic device, a collocated user corresponds to a local user and a non-collocated user corresponds to a remote user. As similarly discussed above, the three-dimensional environment optionally includes visual representations (e.g., avatars or virtual canvases) corresponding to the remote users of the electronic devices that are non-collocated in the multi-user communication session. In some examples, as discussed below, the presentation of the visual representations of the non-collocated users (e.g., the avatars and/or virtual canvases) in the three-dimensional environment within a multi-user communication session that includes collocated and non-collocated users (e.g., relative to a first electronic device) is based on data and/or other indications transmitted between the electronic devices associated with the collocated users within the multi-user communication session.

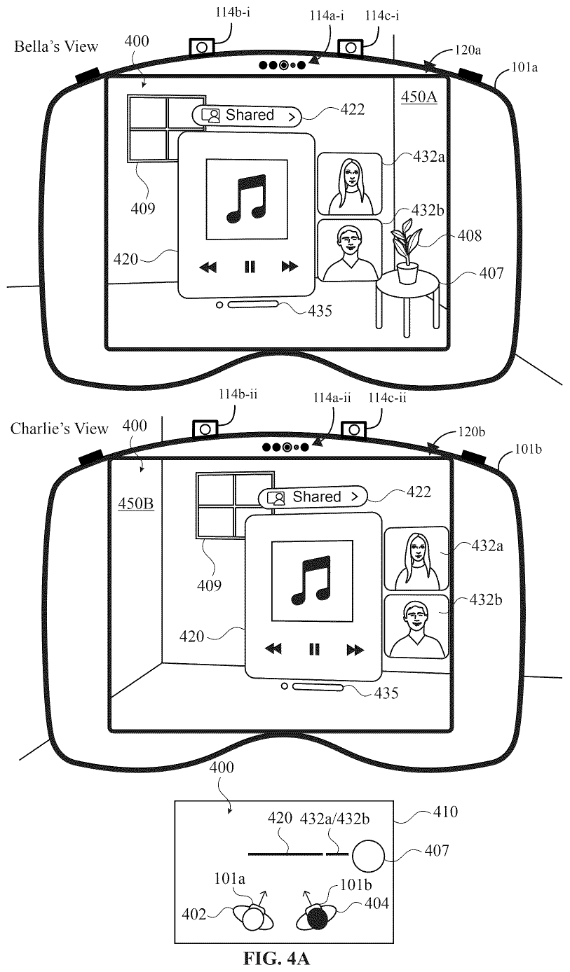

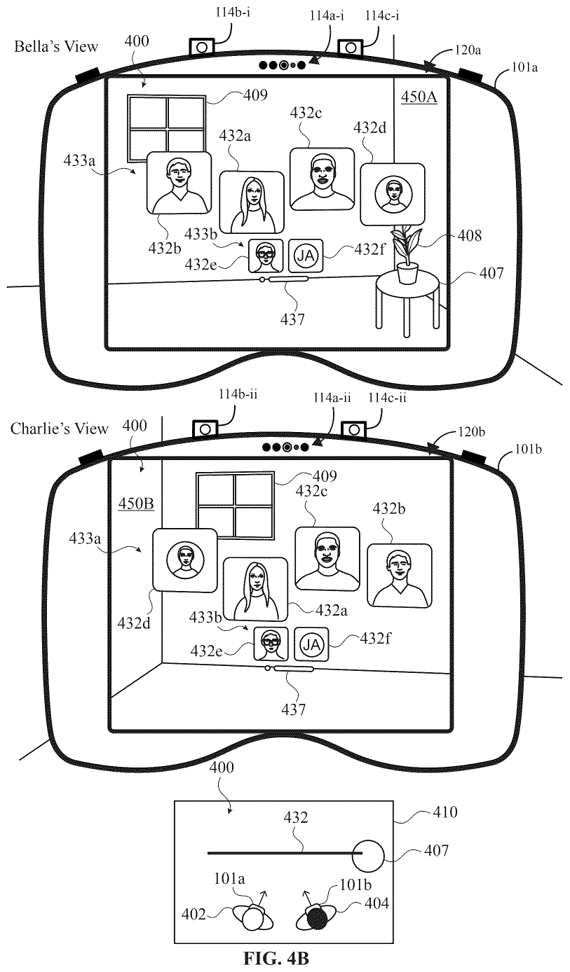

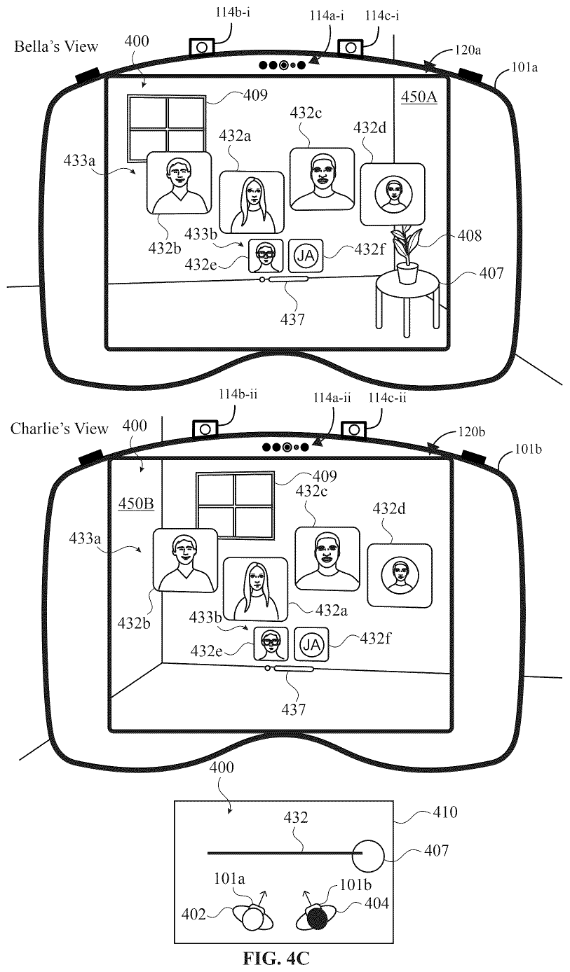

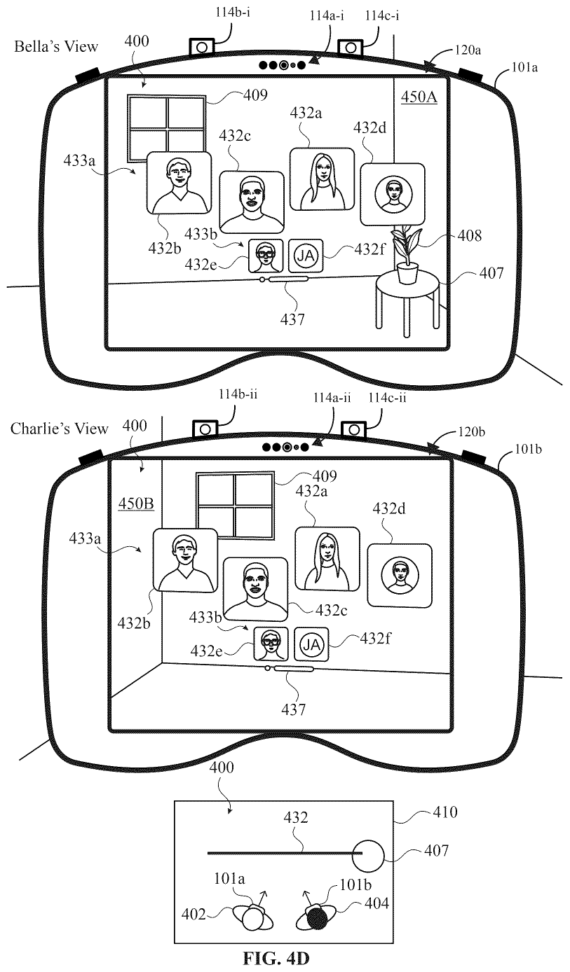

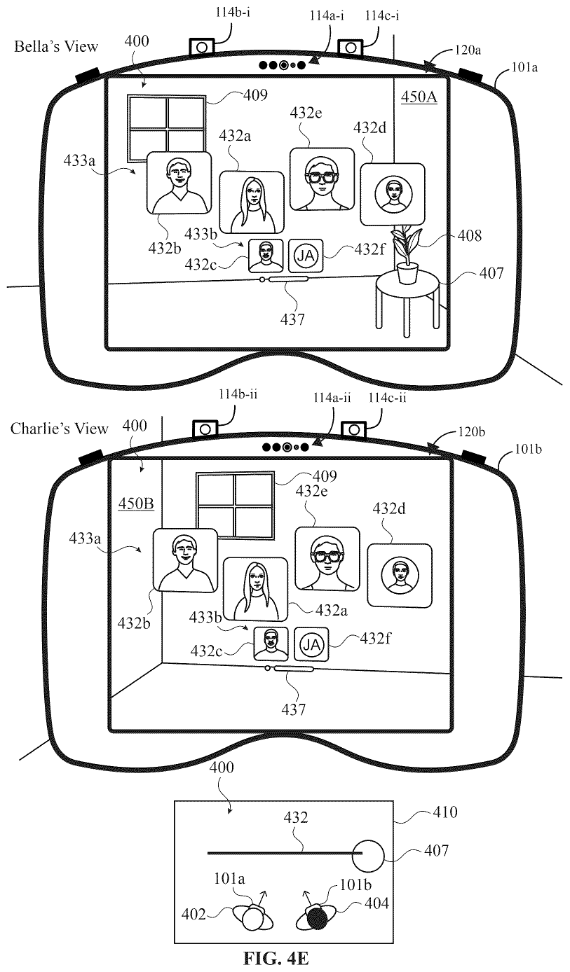

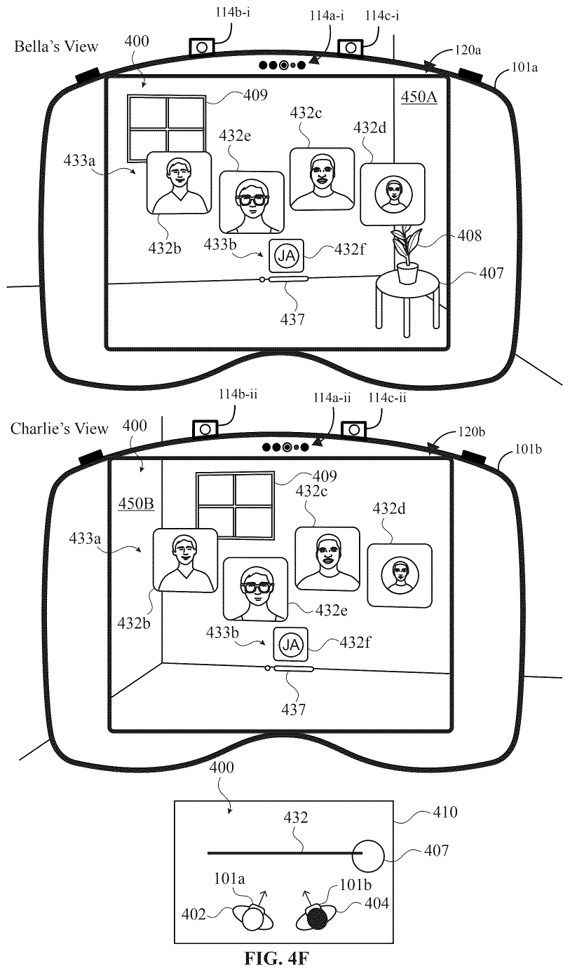

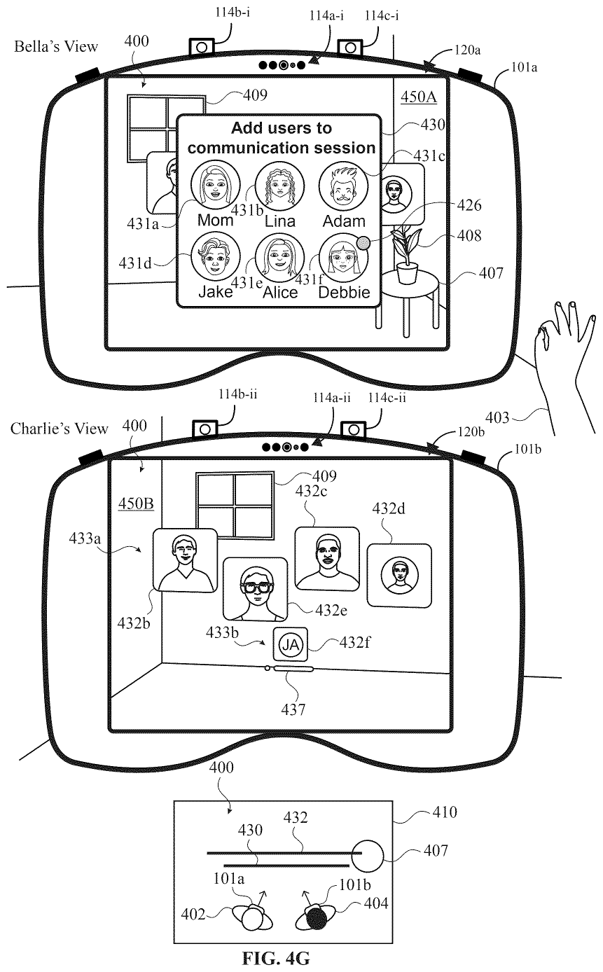

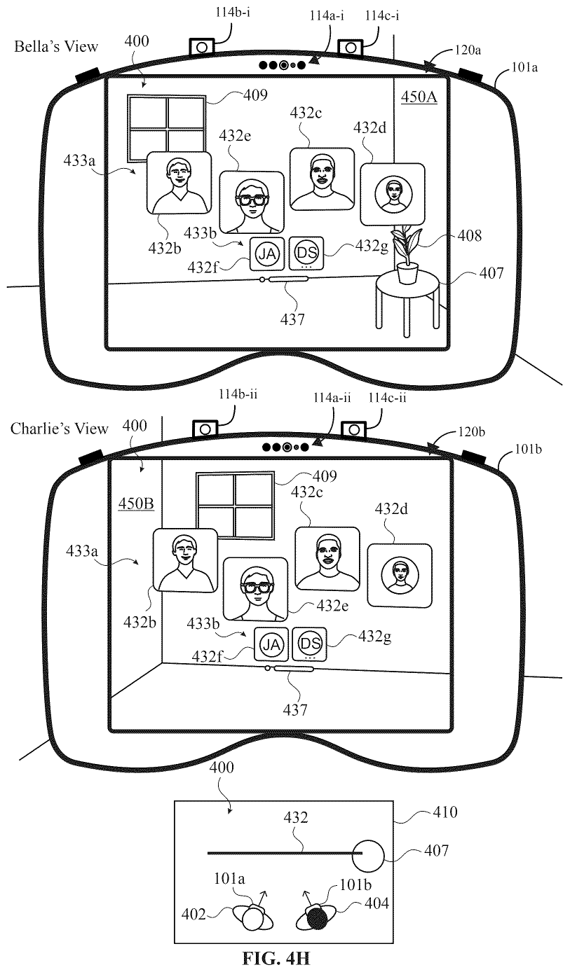

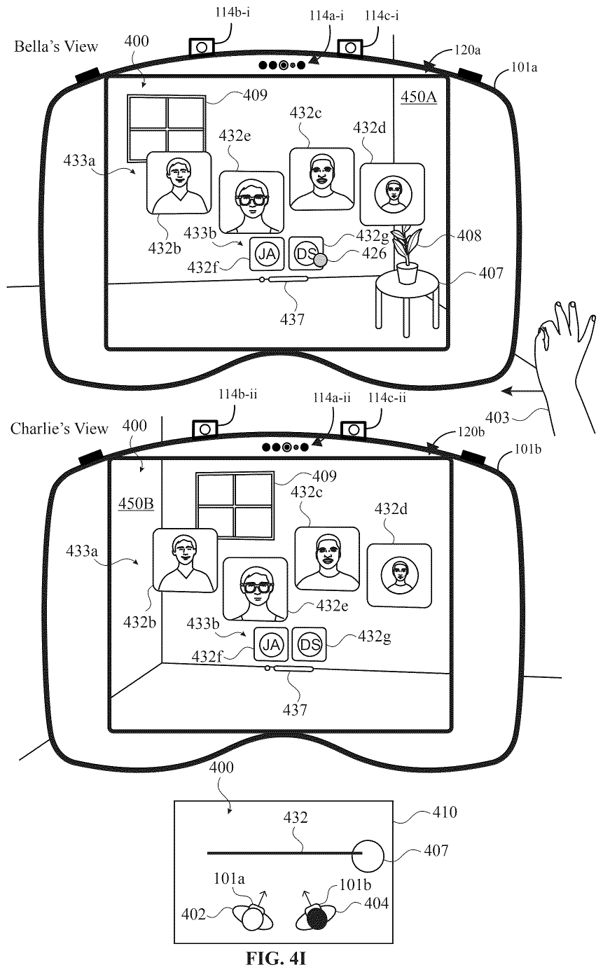

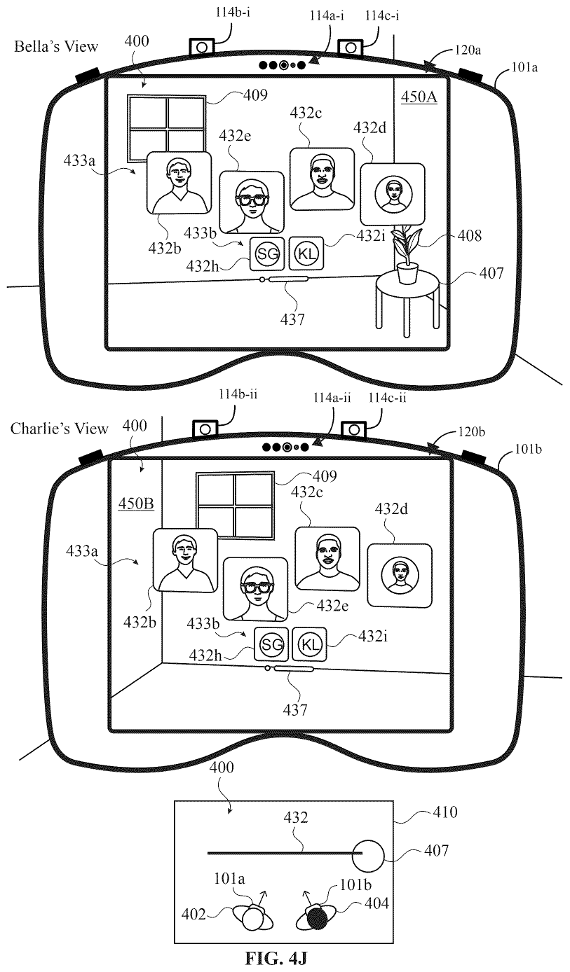

FIGS. 4A-4J illustrate examples of maintaining visual consistency of a visual representation of a remote user in a three-dimensional environment within a multi-user communication session that includes collocated and non-collocated users according to some examples of the disclosure. In some examples, while a first electronic device 101a is in the multi-user communication session with a second electronic device 101b, three-dimensional environment 450A is presented using the first electronic device 101a (e.g., via display 120a) and three-dimensional environment 450B is presented using the second electronic device 101b (e.g., via display 120b). In some examples, the electronic devices 101a/101b optionally correspond to or are similar to electronic devices 360/370 discussed above and/or electronic devices 260/270 in FIG. 2. In some examples, as shown in overhead view 410 in FIG. 4A, the first electronic device 101a is being used by (e.g., worn on a head of) a first user 402 (e.g., Bella) and the second electronic device 101b is being used by (e.g., worn on a head of) a second user 404 (e.g., Charlie).

In FIG. 4A, as indicated in the overhead view 410, the first electronic device 101a and the second electronic device 101b are collocated in physical environment 400. For example, the first electronic device 101a and the second electronic device 101b are both located in a same room that includes window 409, stand 407 and houseplant 408. In some examples, the determination that the first electronic device 101a and the second electronic device 101b are collocated in the physical environment 400 is based on a distance between the first electronic device 101a and the second electronic device 101b. For example, in FIG. 4A, the first electronic device 101a and the second electronic device 101b are collocated in the physical environment 400 because the first electronic device 101a is within a threshold distance (e.g., 0.1, 0.5, 1, 2, 3, 5, 10, 15, 20, etc. meters) of the second electronic device 101b. In some examples, the determination that the first electronic device 101a and the second electronic device 101b are collocated in the physical environment 400 is based on communication between the first electronic device 101a and the second electronic device 101b. For example, in FIG. 4A, the first electronic device 101a and the second electronic device 101b are configured to communicate (e.g., wirelessly, such as via Bluetooth, Wi-Fi, or a server (e.g., wireless communications terminal)). In some examples, the first electronic device 101a and the second electronic device 101b are connected to a same wireless network in the physical environment 400. In some examples, the determination that the first electronic device 101a and the second electronic device 101b are collocated in the physical environment 400 is based on a strength of a wireless signal transmitted between the electronic devices 101a and 101b. For example, in FIG. 4A, the first electronic device 101a and the second electronic device 101b are collocated in the physical environment 400 because a strength of a Bluetooth signal (or other wireless signal) transmitted between the electronic devices 101a and 101b is greater than a threshold strength. In some examples, the determination that the first electronic device 101a and the second electronic device 101b are collocated in the physical environment 400 is based on visual detection of the electronic devices 101a and 101b in the physical environment 400. For example, in FIG. 4A, prior to and/or when initializing the multi-user communication session in the physical environment 400, the second electronic device 101b is positioned in a field of view of the first electronic device 101a (e.g., because the second user 404 is standing in the field of view of the first electronic device 101a), which enables the first electronic device 101a to visually detect (e.g., identify or scan, such as via object detection or other image processing techniques) the second electronic device 101b (e.g., in one or more images captured by the first electronic device 101a, such as via external image sensors 114b-i and 114c-i). Additionally or alternatively, prior to and/or when initializing the multi-user communication session, the first electronic device 101a is optionally positioned in a field of view of the second electronic device 101b (e.g., because the first user 402 is standing in the field of view of the second electronic device 101b), which enables the second electronic device 101b to visually detect the first electronic device 101a (e.g., in one or more images captured by the second electronic device 101b, such as via external image sensors 11b-ii and 114c-ii). In some examples, the determination that the first electronic device 101a and the second electronic device 101b are collocated in the physical environment 400 is based on visual detection of one or more same (e.g., overlapping) features or portions of the physical environment 400. For example, as mentioned above, the physical environment 400 includes one or more physical objects, such as the window 409, stand 407 and houseplant 408, and/or one or more physical surfaces, such as the walls, floor, and ceiling of the room in which the electronic devices 101a/101b are located. In the example of FIG. 4A, the first electronic device 101a and the second electronic device 101b determine that the electronic devices are collocated in the physical environment 400 based on visual detection of the window 409, stand 407, houseplant 408, and/or the walls and floor of the room, which are visible in the field of view of both of the electronic devices 101a/101b (e.g., in the one or more images captured by the first electronic device 101a and the second electronic device 101b).

In some examples, as shown in FIG. 4A, the three-dimensional environments 450A/450B include captured portions of the physical environment 400 in which the electronic devices 101a/101b are located. For example, because the first electronic device 101a and the second electronic device 101b are collocated in the physical environment 400, the three-dimensional environments 450A and 450B include the window 409 (e.g., a representation of the window), the stand 407 (e.g., a representation of the stand) and the houseplant 408 (e.g., a representation of the houseplant), but from the viewpoints of the first electronic device 101a and the second electronic device 101b, as shown in FIG. 4A. In some examples, the representations include portions of the physical environment 400 viewed through a transparent or translucent display of the electronic devices 101a and 101b. In some examples, the three-dimensional environments 450A/450B have one or more characteristics of the three-dimensional environments 350A/350B described above with reference to FIG. 3.

As described above with reference to FIG. 3, while electronic devices are communicatively linked in a multi-user communication session, users may be represented by visual representations (e.g., three-dimensional and/or two-dimensional representations) corresponding to the users of the electronic devices. In FIG. 4A, because the first electronic device 101a and the second electronic device 101b are collocated in the physical environment 400, the users of the electronic devices 101a and 101b are represented in the multi-user communication session via their physical personas (e.g., bodies) that may be visible in passthrough of the physical environment 400 (e.g., rather than via virtual avatars). For example, as indicated in the overhead view 410 in FIG. 4A, the second user 404 is not currently visible in the field of view of the first electronic device 101a and the first user 402 is not currently visible in the field of view of the second electronic device 101b based on the physical locations of the users 404/402 in the physical environment 400, but because the users 404/402 are collocated in the physical environment 400, the first electronic device 101a and the second electronic device 101b forgo displaying visual representations (e.g., avatars) of the users 404/402. As discussed in more detail below, users who are non-collocated in the physical environment 400 (e.g., remote users) and who join and/or are participating in the multi-user communication session are optionally represented via visual representations (e.g., an avatar or a virtual canvas) in the three-dimensional environments 450A and 450B.

As similarly described above with reference to FIG. 3, while the first user 402 of the first electronic device 101a and the second user 404 of the second electronic device 101b are collocated in the physical environment 400 and while the first electronic device 101a is in the multi-user communication session with the second electronic device 101b, the first user 402 and the second user 404 may be in a first spatial group within the multi-user communication session In some examples, the first spatial group has one or more characteristics of spatial group 340 discussed above with reference to FIG. 3. As similarly described above, while the first user 402 and the second user 404 are in the first spatial group within the multi-user communication session, the users have a first spatial arrangement in the shared three-dimensional environment (e.g., represented by the locations of and/or distance between the users 402 and 404 in the overhead view 410 in FIG. 4A) determined by the physical locations of the electronic devices 101a and 101b in the physical environment 400. Particularly, the first electronic device 101a and the second electronic device 101b experience spatial truth within the first spatial group as dictated by the physical locations of and/or orientations of the first user 402 and the second user 404, respectively.

In some examples, as similarly described above with reference to FIG. 3, while the first electronic device 101a is in the multi-user communication session with the second electronic device 101b, virtual content is able to be shared and/or interacted between the first electronic device 101a and the second electronic device 101b in the three-dimensional environments 450A/450B. For example, as shown in FIG. 4A, the first electronic device 101a and the second electronic device 101b are displaying virtual object 420 in the three-dimensional environment 450A/450B. In some examples, the virtual object 420 corresponds to an application window (e.g., a user interface), such as a media player (e.g., music player) application running on the first electronic device 101a and/or the second electronic device 101b. In some examples, the virtual object 420 is shared between the first electronic device 101a and the second electronic device 101b in the multi-user communication session, such that the content of the virtual object 420 (e.g., the music player user interface) is visible to and/or interactive to the first user 402 and the second user 404 via their respective electronic devices 101a/101b, as indicated by pill 422 displayed with the virtual object 420. In some examples, the pill 422 is selectable to initiate one or more sharing operations associated with the virtual object 420. For example, the pill 422 is selectable (e.g., via an air gesture, such as an air pinch or tap gesture) to share (e.g., and/or cease sharing) the content of the virtual object 420 in the multi-user communication session. Additionally, in some examples, as shown in FIG. 4A, the virtual object 420 is displayed with and/or includes grabber bar 435, which is optionally selectable to initiate movement of the virtual object 420 in the three-dimensional environments 450A/450B.

In FIG. 4A, the first user 402 of the first electronic device 101a and the second user 404 of the second electronic device 101b are in the multi-user communication session with a plurality of remote users (e.g., non-collocated users) who are virtually represented by a plurality of visual representations in the three-dimensional environments 450A/450B. For example, as shown in FIG. 4A, the three-dimensional environments 450A/450B include a first virtual canvas 432a (optionally a two-dimensional representation) corresponding to a third user of a third electronic device (not shown) and a second virtual canvas 432b corresponding to a fourth user of a fourth electronic device (not shown). In some examples, the first virtual canvas 432a and the second virtual canvas 432b include an image or other visual representation of their respective user, such as a photograph of the respective user, a drawing, cartoon, icon, or other image of the respective user, a (e.g., live) camera feed of the respective user (e.g., captured via one or more cameras of their electronic device), and/or a two-dimensional avatar of the respective user. In some examples, though not illustrated in FIG. 4A, the first virtual canvas 432a and the second virtual canvas 432b include a name, label, or other textual indication identifying the third user and the fourth user in the three-dimensional environment 450A/450B.

In FIG. 4A, the first virtual canvas 432a and the second virtual canvas 432b have a respective spatial arrangement in the three-dimensional environment 450A/450B relative to the virtual object 420. For example, as shown in FIG. 4A, because the virtual object 420 corresponds to a shared object in the multi-user communication session (e.g., as described above and as indicated by the pill 422), the first electronic device 101a and the second electronic device 101b provide a vertical arrangement of the first virtual canvas 432a and the second virtual canvas 432b relative to the virtual object 420 in the three-dimensional environment 450A/450B. Particularly, in some examples, as shown in FIG. 4A, the first virtual canvas 432a and the second virtual canvas 432b are arranged in a column adjacent to (e.g., to a right side or edge of) the virtual object 420 in the three-dimensional environment 450A/450B from the viewpoints of the first electronic device 101a and the second electronic device 101b. In some examples, while the first virtual canvas 432a and the second virtual canvas 432b are arranged in the vertical arrangement relative to the virtual object 420, the first virtual canvas 432a and the second virtual canvas 432b are docked to the virtual object 420. For example, if movement input directed to the virtual object 420 is detected (e.g., such as an air pinch and drag gesture directed to the grabber bar 435) and causes the virtual object 420 to be repositioned in the three-dimensional environment 450A/450B, the first virtual canvas 432a and the second virtual canvas 432b are moved with the virtual object 420 in the three-dimensional environment 450A/450B from the viewpoints of the first electronic device 101a and the second electronic device 101b. It should be understood that, in some examples, the first virtual canvas 432a and the second virtual canvas 432b are alternatively arranged in a column to a left side or edge of the virtual object 420 in the three-dimensional environment 450A/450B from the viewpoints of the first electronic device 101a and the second electronic device 101b. In some examples, the particular side or edge of the virtual object 420 to which the first virtual canvas 432a and the second virtual canvas 432b are aligned in the three-dimensional environment 450A/450B is predefined (e.g., as a default) by the first electronic device 101a and/or the second electronic device 101b and/or is determined based on the content or content type of the virtual object 420. Alternatively, in some examples, the particular side or edge of the virtual object 420 to which the first virtual canvas 432a and the second virtual canvas 432b are aligned in the three-dimensional environment 450A/450B is determined based on user input and/or user preference (e.g., in user settings of the first electronic device 101a and/or the second electronic device 101b).

In some examples, while the virtual object 420 is shared in the multi-user communication session, the first virtual canvas 432a and the second virtual canvas 432b remain anchored to the virtual object 420 in the vertical arrangement illustrated in FIG. 4A. For example, if the virtual object 420 is unshared in the multi-user communication session and/or ceases to be displayed in the three-dimensional environment 450A/450B, the first virtual canvas 432a and the second virtual canvas 432b are redisplayed in an alternative spatial arrangement, as discussed in more detail below with reference to FIG. 4B. Additionally, in some examples, an order or spatial distribution of the first virtual canvas 432a and the second virtual canvas 432b within the vertical arrangement illustrated in FIG. 4A is based on and/or corresponds to a prioritization order of the remote users in the multi-user communication session. For example, as discussed in more detail below, a position of the first virtual canvas 432a at a top of the column of virtual canvases in FIG. 4A indicates that the third user (e.g., represented by the first virtual canvas 432a) has or is associated with a first prioritization value or indicator that is higher than or greater than a second prioritization value or indicator associated with the fourth user (e.g., represented by the second virtual canvas 432b at the bottom of the column of virtual canvases). In some examples, the prioritization order of the remote users in the multi-user communication session is determined based on prioritization data compiled by the first electronic device 101a and the second electronic device 101b (e.g., the local users in the multi-user communication session). Additional details regarding the determination of the prioritization data are provided below. Additionally, in some examples, though two virtual canvases are displayed at a time in the column of virtual tiles while the virtual object 420 is shared in the multi-user communication session, additional virtual canvases (e.g., representing additional remote users in the multi-user communication session) are associated with the column of the virtual tiles (e.g., though are not expressly visible or displayed within the column in the three-dimensional environment 450A/450B). For example, as described in more detail below, if the prioritization data changes or is updated, which causes the prioritization order of the remote users to change or to be updated, the order or spatial distribution of the virtual canvases within the column may change, optionally causing a third virtual canvas (e.g., representing a fifth user of a fifth electronic device) to be displayed and visible within the column (e.g., and therefore causing the first virtual canvas 432a or the second virtual canvas 432b to no longer be displayed or visible within the column) in the three-dimensional environment 450A/450B.

As alluded to above, in some examples, the spatial arrangement of the virtual canvases representing remote users in the multi-user communication session changes and/or is alternatively provided if content is not being shared in the multi-user communication session. For example, in FIG. 4B, the three-dimensional environment 450A/450B does not include a shared object, such as virtual object 420 described above. Accordingly, as shown in FIG. 4B, in some examples, the virtual canvases representing the remote users in the multi-user communication session are provided in an alternative spatial arrangement in the three-dimensional environment 450A/450B. Particularly, as illustrated in FIG. 4B, the virtual canvases are optionally displayed within a horizontal array of virtual canvases in the three-dimensional environment 450A/450B. For example, as shown in FIG. 4B, because the three-dimensional environment 450A/450B does not include a shared object, the virtual canvases are arranged within two rows 433a and 433b of virtual canvases from the viewpoints of the first electronic device 101a and the second electronic device 101b. In some examples, as similarly discussed above, each virtual canvas corresponds to and/or visually represents a remote user within the multi-user communication session. For example, as shown in FIG. 4B, in addition to the first virtual canvas 432a and the second virtual canvas 432b discussed above, the three-dimensional environment 450A/450B includes a third virtual canvas 432c corresponding to a fifth user of a fifth electronic device, a fourth virtual canvas 432d corresponding to a sixth user of a sixth electronic device, a fifth virtual canvas 432e corresponding to a seventh user of a seventh electronic device, and a sixth virtual canvas 432f corresponding to an eighth user of an eighth electronic device. In some examples, as shown in FIG. 4B, though the virtual canvases 432a-432f are arranged within the two rows 433a and 433b in the three-dimensional environment 450A/450B, the virtual canvases in the first row 433a are not axis-aligned like the virtual canvases in the second row 433b. For example, as shown in FIG. 4B, the virtual canvases in the first row 433a in the three-dimensional environment 450A/450B have a staggered spatial alignment while the virtual canvases in the second row 433b are axis-aligned (e.g., are arranged in a straight line horizontally) from the viewpoints of the first electronic device 101a and the second electronic device 101b. Additionally, in some examples, as shown in FIG. 4B, the virtual canvases in the first row 433a have a size that is different from (e.g., larger than) a size of the virtual canvases in the second row 433b, as discussed in more detail below.

In some examples, as shown in FIG. 4B, while the virtual canvases 432a-432f are displayed in the three-dimensional environment 450A/450B without shared content being displayed in the three-dimensional environment 450A/450B, the virtual canvases 432a-432f are displayed with grabber bar 437. In some examples, the grabber bar 437 has one or more characteristics of the grabber bar 435 discussed above. For example, the grabber bar 437 is selectable (e.g., via an air pinch gesture) to initiate movement of the virtual canvases 432a-432f in the three-dimensional environment 450A/450B. In some examples, in response to receiving such an input, the first electronic device 101a and the second electronic device 101b move and/or reposition the virtual canvases 432a-432f in unison in the three-dimensional environment 450A/450B.

As alluded to above, it may be advantageous to provide mechanisms for, while the first user 402 and the second user 404 are in the multi-user communication session with the plurality of remote users represented by the virtual canvases 432a-432f, maintaining visual and/or spatial consistency of the virtual canvases 432a-432f across the first electronic device 101a and the second electronic device 101b. Particularly, it may be desirable to provide the virtual canvases 432a-432f in a same order and in a same spatial distribution at both the first electronic device 101a and the second electronic device 101b. For example, in FIG. 4B, the order and spatial distribution of the virtual canvases 432a-432f are different between the first electronic device 101a and the second electronic device 101b, as illustrated by the second virtual canvas 432b being displayed at the leftmost position within the first row 433a in the three-dimensional environment 450A but being displayed at the rightmost position in the first row 433a in the three-dimensional environment 450B. In such an instance, because the second virtual canvas 432b representing the fourth user in the multi-user communication session is spatially located at different positions within the first row 433a in the three-dimensional environment 450A at the first electronic device 101a and the three-dimensional environment 450B at the second electronic device 101b, a spatial understanding and/or awareness between the first user 402 and the second user 404 are different and conflicting as they pertain to the virtual canvases 432a-432f, which may hinder and/or reduce the user experience in the multi-user communication session.

Accordingly, in some examples, a prioritization order is established by the first electronic device 101a and/or the second electronic device 101b that enables the spatial arrangement and spatial distribution of the virtual canvases 432a-432b to be consistent between the first electronic device 101a and the second electronic device 101b. For example, as shown in FIG. 4C, by synchronizing the prioritization order of the virtual canvases 432a-432f, the first electronic device 101a and the second electronic device 101b provide a same spatial arrangement and spatial distribution of the virtual canvases 432a-432f in the three-dimensional environment 450A/450B. Particularly, in FIG. 4C, the virtual canvases 432a-432f are arranged in the two rows 433a and 433b at both electronic devices 101a and 101b and are distributed in the same order within the two rows 433a and 433b at both electronic devices 101a and 101b, therefore advantageously facilitating visual consistency for the local users (e.g., the first user 402 and the second user 404) in the multi-user communication session.

In some examples, the prioritization order of the virtual canvases 432a-432f is determined by the first electronic device 101a and/or the second electronic device 101b based on and/or according to prioritization data associated with the remote users and that is collected by and/or compiled by the first electronic device 101a and/or the second electronic device 101b during the multi-user communication session. In some examples, the prioritization data includes user data and/or input data indicative of user activity that are provided by each of the electronic devices associated with the remote users in the multi-user communication session. As an example, the prioritization data includes data indicative of camera and/or video activity of the remote users in the multi-user communication session. For example, the electronic devices associated with the remote users in the multi-user communication session transmit data to the first electronic device 101a and the second electronic device 101b that indicates whether a particular remote user's camera and/or video feed is currently on/active. As another example, the data transmitted to the first electronic device 101a and the second electronic device 101b indicates, if the remote user's camera and/or video feed is currently on/active, whether there is motion or movement detected in the video feed (e.g., whether the remote user is moving, which may be indicative of speaking), as detected by one or more cameras of the respective electronic device. By way of illustration, for example, the second virtual canvas 432b and the first virtual canvas 432a represent remote users whose camera feed is currently on, and the fourth virtual canvas 432d and the sixth virtual canvas 432f represent remote users whose camera feed is currently off (e.g., and are being represented by two-dimensional images), as shown in FIG. 4C. In some examples, the prioritization data includes data indicative of audio activity of the remote users in the multi-user communication session. For example, the electronic devices associated with the remote users in the multi-user communication session transmit data to the first electronic device 101a and the second electronic device 101b that indicates whether a particular remote user's audio function (e.g., microphone) is currently on/active. Further, in some examples, the data transmitted to the first electronic device 101a and the second electronic device 101b indicates, if the remote user's audio function is currently on/active, whether there is audio being detected by one or more microphones of the respective electronic device (e.g., whether the remote user is actively speaking or talking).

In some examples, using the data indicative of user activity that is provided by the electronic devices associated with the remote users in the multi-user communication session, the first electronic device 101a and/or the second electronic device 101b compile the prioritization data and assign each remote user a prioritization value (e.g., a unitless number or other discrete identifier between a predefined range (e.g., 0 and 255)) from which the prioritization order is determined. For example, using the video and/or audio activity discussed above of the remote users in the multi-user communication session, the first electronic device 101a and/or the second electronic device 101b determine a ranking of the remote users from most active to least active in the multi-user communication session. As an example, a respective remote user who has their camera feed active and is actively speaking while in the multi-user communication session is assigned a higher prioritization value than another remote user who has their camera feed off and is speaking less or has their audio feed off while in the multi-user communication session. In some examples, the first electronic device 101a and/or the second electronic device 101b determine the prioritization order of the virtual canvases 432a-432f in the three-dimensional environment 450A/450B after assigning each remote user a prioritization value according to the prioritization data described above.

In some examples, the particular order or spatial distribution of the virtual canvases 432a-432f within the two rows 433a and 433b in the three-dimensional environment 450A/450B is based on the prioritization order discussed above. For example, in FIG. 4B, the leftmost position within the first row 433a in the three-dimensional environment 450A/450B corresponds to a highest priority position in the horizontal spatial arrangement of virtual canvases 432a-432f and the rightmost position within the second row 433b in the three-dimensional environment 450A/450B corresponds to a lowest priority position in the horizontal spatial arrangement of virtual canvases 432a-432f. Accordingly, in the example of FIG. 4B, the fourth user represented by the second virtual canvas 432b has been assigned the highest prioritization value based on the prioritization data discussed above, which causes the first electronic device 101a and the second electronic device 101b to display the second virtual canvas 432b at the leftmost position within the first row 433a in the three-dimensional environment 450A/450B from the viewpoints of the first electronic device 101a and the second electronic device 101b. Similarly, in the example of FIG. 4B, the eighth user represented by the sixth virtual canvas 432f has been assigned the lowest prioritization value based on the prioritization data discussed above, which causes the first electronic device 101a and the second electronic device 101b to display the sixth virtual canvas 432f at the rightmost position within the second row 433b in the three-dimensional environment 450A/450B from the viewpoints of the first electronic device 101a and the second electronic device 101b.

In some examples, the two rows 433a and 433b illustrated in FIG. 4C correspond to two classes or groups of remote users in the multi-user communication session. For example, in FIG. 4C, the four virtual canvases 432a-432d displayed in the first row 433a within the horizontal arrangement of virtual canvases correspond to the four remote users having been assigned the top four (e.g., four highest) prioritization values according to the prioritization data, as discussed above, and the remaining virtual canvases (e.g., the virtual canvases 432e/432f) displayed in the second row 433b correspond to the remaining remote users, optionally in no particular order. Particularly, in some examples, the four positions within the first row 433a are determined according to the prioritization order discussed above, while the two (or more) positions within the second row 433b are determined arbitrarily (e.g., without regard for the prioritization values that fall outside of the top four values). Accordingly, in some examples, as alluded to above, the virtual canvases displayed in the first row 433a in the three-dimensional environment 450A/450B are displayed with a larger size (e.g., indicating greater prominence or priority) than the virtual canvases displayed in the second row 433b in the three-dimensional environment 450A/450B from the viewpoints of the first electronic device 101a and the second electronic device 101b. Providing virtual canvases representing remote users who are more active in the multi-user communication session in a prioritized row and/or with a size that indicates a greater prioritization or prominence among the remote users in the multi-user communication session, which provides the local users with a visual indication of the more active participants in the multi-user communication session and/or ensures less active participants are less visually prominent in the three-dimensional environment, thereby increasing user privacy, as one benefit.

In some examples, the order or spatial distribution of the virtual canvases in the horizontal arrangement shown in FIG. 4C is updated based on and/or in response to changes in the prioritization data used to determine the prioritization order of the virtual canvases in the three-dimensional environment 450A/450B. For example, from FIG. 4C to FIG. 4D, the first electronic device 101a and/or the second electronic device 101b receive updated data from one or more electronic devices associated with the remote users in the multi-user communication session that causes the first electronic device 101a and/or the second electronic device 101b to update the prioritization data and thus, the prioritization order that defines the order or spatial distribution of the virtual canvases displayed in the three-dimensional environment 450A/450B. Particularly, in some examples, as shown in FIG. 4D, the first electronic device 101a and the second electronic device 101b update the positions of the first virtual canvas 432a representing the third user and the third virtual canvas 432c representing the fifth user within the first row 433a of the horizontal spatial arrangement in the three-dimensional environment 450A/450B. For example, from FIG. 4C to FIG. 4D, the first electronic device 101a and the second electronic device 101b swap the positions of the first virtual canvas 432a and the third virtual canvas 432c in the first row 433a in the three-dimensional environment 450A/450B. In some examples, as discussed in more detail below, the updated prioritization data indicates that the prioritization value assigned to the fifth user represented by the third virtual canvas 432c has exceeded or surpassed the prioritization value assigned to the third user represented by the first virtual canvas 432a in the three-dimensional environment 450A/450B.

In some examples, detecting the change in the prioritization data includes and/or is based on receiving data from the third electronic device associated with the third user and/or the fifth electronic device associated with the fifth user indicating that user activity of the third user and/or the fifth user in the multi-user communication session has changed. Particularly, the first electronic device 101a and/or the second electronic device 101b optionally determine that the video and/or audio activity of the fifth user has surpassed that of the third user, which causes the prioritization value assigned to the fifth user to surpass the prioritization value assigned to the third user in the multi-user communication session. Accordingly, as discussed above and as shown in FIG. 4D, updated prioritization data causes the first electronic device 101a and the second electronic device 101b to update the prioritization order of the virtual canvases 432a-432f in the three-dimensional environment 450A/450B, notably the positions of the first virtual canvas 432a corresponding to the third user and the third virtual canvas 432c corresponding to the fifth user in the multi-user communication session.

In some examples, one of the electronic devices associated with the local users in the multi-user communication session updates the order or spatial distribution of the virtual canvases 432a-432f in its local three-dimensional environment at the direction or instruction of another electronic device associated with a local user in the multi-user communication session. For example, lag or other delay in updating the prioritization data that determines the prioritization order of the virtual canvases 432a-432f (e.g., such as due to connectivity issues (e.g., Wi-Fi or Bluetooth connectivity issues or lag), device operation delay or reduced performance (e.g., due to low power or increased processing demands due to multiple applications running on the electronic device), etc.) may cause the first electronic device 101a or the second electronic device 101b to delay in updating display of the order or spatial distribution of the virtual canvases 432a-432f in the manner discussed above, which would break the visual consistency between the display of the virtual canvases 432a-432f between the electronic devices 101a and 101b. Accordingly, in some examples, the first electronic device 101a or the second electronic device 101b transmits a signal, data, or other instructions (e.g., commands) to the other electronic device that causes the other electronic device to update display of the virtual canvases 432a-432f in the three-dimensional environment 450A or the three-dimensional environment 450B. For example, in FIG. 4D, after updating the prioritization data based on the updated user activity data provided by the third electronic device and the fifth electronic device as discussed above and while the second electronic device 101b is experiencing lag or other performance delay, the first electronic device 101a determines that the prioritization order of the virtual canvases 432a-432f is to be changed in accordance with the updated prioritization data, and in response, transmits display data to the second electronic device 101b (e.g., including the updated prioritization data and other instructions) that causes the second electronic device 101b to update display of the virtual canvases 432a-432f in the three-dimensional environment 450B. As an example, the display data transmitted to the second electronic device 101b includes instructions to swap the positions of the third virtual canvas 432c and the first virtual canvas 432a in the first row 433a in the three-dimensional environment 450B as similarly discussed above. In some examples, the display data transmitted to the second electronic device 101b includes the updated prioritization data, which enables the second electronic device 101b to locally and independently update the prioritization order of the virtual canvases 432a-432f, thereby enabling and causing the second electronic device 101b to swap the positions of the third virtual canvas 432c and the first virtual canvas 432a in the first row 433a in the three-dimensional environment 450B. Alternatively, in the example of FIG. 4D, after updating the prioritization data based on the updated user activity data provided by the third electronic device and the fifth electronic device as discussed above and while the first electronic device 101a is experiencing lag or other performance delay, the second electronic device 101b determines that the prioritization order of the virtual canvases 432a-432f is to be changed in accordance with the updated prioritization data, and in response, transmits display data to the first electronic device 101a (e.g., including the updated prioritization data and other instructions) that causes the first electronic device 101a to update display of the virtual canvases 432a-432f in the three-dimensional environment 450B as similarly discussed above.

In some examples, the transmission of the display data (e.g., that includes instructions or other data) discussed above for causing the first electronic device 101a or the second electronic device 101b to update display of the order or spatial distribution of the virtual canvases 432a-432f occurs independently of or without detecting an indication of the first electronic device 101a or the second electronic device 101b experiencing lag or other performance delay. For example, when the first electronic device 101a or the second electronic device 101b detects a change in the prioritization data that causes the prioritization order of the virtual canvases 432a-432f to be updated, the first electronic device 101a or the second electronic device 101b transmits the display data to the other electronic device indicating that the prioritization data has changed. In some such examples, the first electronic device 101a or the second electronic device 101b, following receipt of the display data from the other electronic device, compares the updated prioritization data with the current prioritization data at the first electronic device 101a or the second electronic device 101b, and if discrepancies exist, the first electronic device 101a or the second electronic device 101b updates the prioritization order based on the updated prioritization data (e.g., even though the first electronic device 101a or the second electronic device 101b may not necessarily be experiencing lag or performance delays). Accordingly, in this way, the visual consistency of the visual representations (e.g., the virtual canvases) corresponding to the remote users in the multi-user communication session is maintained for the local users in the multi-user communication session, accounting for any lag or performance delays experienced by the electronic devices associated with the local users, thereby maintaining the user experience within the multi-user communication session, as one benefit.

In some examples, the first electronic device 101a and the second electronic device 101b selectively (e.g., based on satisfaction of one or more criteria) update the order or spatial distribution of the virtual canvases 432a-432f in response to detecting a change in the prioritization data associated with the remote users in the multi-user communication session. Particularly, in certain instances, it may be desirable to reduce the frequency with which the order or spatial distribution of the virtual canvases 432a-432f is updated in the three-dimensional environment 450A/450B, for example, to help reduce eye strain or other discomforts that may be experienced by the local users (e.g., the first user 402 and the second user 404) at their respective electronic devices due to the repeated updating of the display of the virtual canvases 432a-432f in the three-dimensional environment 450A/450B. In some examples, the change in the prioritization data described above with reference to FIG. 4D is not sufficient to cause the first electronic device 101a and the second electronic device 101b to update the order or spatial distribution of the virtual canvases 432a-432f in the three-dimensional environment 450A/450B. For example, despite the prioritization value assigned to the fifth user represented by the third virtual canvas 432c surpassing the prioritization value assigned to the third user represented by the first virtual canvas 432a when the prioritization data is updated as discussed above, the first electronic device 101a and the second electronic device 101b forgo swapping the positions of the first virtual canvas 432a and the third virtual canvas 432c in FIG. 4D. Accordingly, in some examples, the order or spatial distribution of the virtual canvases 432a-432f in the three-dimensional environment 450A/450B remains as that shown in FIG. 4C.

Returning to FIG. 4C, a change in the prioritization data that is sufficient to cause the first electronic device 101a and the second electronic device 101b to update the order or spatial distribution of the virtual canvases 432a-432f in the three-dimensional environment 450A/450B (e.g., satisfying the one or more criteria for updating display of the virtual canvases 432a-432f in the three-dimensional environment 450A/450B) includes a change that causes or indicates a transition of a virtual canvas from the second row 433b to the first row 433a, or vice versa. For example, as discussed previously above, the first row 433a of the virtual canvases in the horizontal spatial arrangement shown in FIG. 4C corresponds to a first group of remote users who have been assigned the four highest prioritization values in the multi-user communication session, and the remaining remote users in the multi-user communication session are visually represented via their respective virtual canvases in the second row 433b of virtual canvases in the horizontal spatial arrangement. Particularly, in some examples, a change in order within a same row in the horizontal spatial arrangement is considered to be of lower significance than a change in order from one row to the other in the horizontal spatial arrangement, as discussed in more detail below.

From FIG. 4C to FIG. 4E, the first electronic device 101a and/or the second electronic device 101b receive updated data from one or more electronic devices associated with the remote users in the multi-user communication session that causes the first electronic device 101a and/or the second electronic device 101b to update the prioritization data that satisfies the one or more criteria and thus, the prioritization order that defines the order or spatial distribution of the virtual canvases displayed in the three-dimensional environment 450A/450B. Particularly, in some examples, as shown in FIG. 4E, the first electronic device 101a and the second electronic device 101b update the positions of the third virtual canvas 432c representing the fifth user and the fifth virtual canvas 432e representing the seventh user within the first row 433a and the second row 433b of the horizontal spatial arrangement in the three-dimensional environment 450A/450B. For example, from FIG. 4C to FIG. 4E, the first electronic device 101a and the second electronic device 101b swap the positions of the third virtual canvas 432c in the first row 433a and the fifth virtual canvas 432e in the second row 433b in the three-dimensional environment 450A/450B. In some examples, as discussed in more detail below, the updated prioritization data indicates that the prioritization value assigned to the seventh user represented by the fifth virtual canvas 432e has exceeded or surpassed the prioritization value assigned to the fifth user represented by the third virtual canvas 432c, and more importantly, that the prioritization value assigned to the seventh user is among the four highest prioritization values in the multi-user communication session (e.g., which causes the fifth virtual canvas 432e to be moved into the first row 433a from the second row 433b in the three-dimensional environment 450A/450B).

In some examples, as similarly discussed above, detecting the change in the prioritization data includes and/or is based on receiving data from the fifth electronic device associated with the fifth user and/or the seventh electronic device associated with the seventh user indicating that user activity of the fifth user and/or the seventh user in the multi-user communication session has changed. Particularly, the first electronic device 101a and/or the second electronic device 101b optionally determine that the video and/or audio activity of the seventh user has surpassed that of the fifth user (without surpassing or also surpassing those of the third user (e.g., represented by the first virtual canvas 432a) and the sixth user (e.g., represented by the fourth virtual canvas 432d)), which causes the prioritization value assigned to the seventh user to surpass the prioritization value assigned to the fifth user in the multi-user communication session. Accordingly, as discussed above and as shown in FIG. 4E, updated prioritization data satisfying the one or more criteria causes the first electronic device 101a and the second electronic device 101b to update the prioritization order of the virtual canvases 432a-432f in the three-dimensional environment 450A/450B, notably the positions of the third virtual canvas 432c corresponding to the fifth user and the fifth virtual canvas 432e corresponding to the seventh user in the multi-user communication session.

In some examples, detecting a change in the prioritization data includes and/or is based on an indication that a number of remote users in the multi-user communication session has changed. For example, the first electronic device 101a and/or the second electronic device 101b update the prioritization order in accordance with the updated prioritization data in accordance with a determination that a remote user has joined or has left the multi-user communication session, which causes the number of active participants in the multi-user communication session to change. As an example, in FIG. 4F, the first electronic device 101a and the second electronic device 101b detect an indication that a remote user has left the multi-user communication session, which causes the number of participants in the multi-user communication session to decrease. Particularly, in FIG. 4F, the third user of the third electronic device has left the multi-user communication session, which causes the first electronic device 101a and the second electronic device 101b to cease display of the visual representation of the third user (e.g., the first virtual canvas 432a) in the three-dimensional environment 450A/450B. In some examples, when the first virtual canvas 432a ceases to be displayed in the three-dimensional environment 450A/450B, the order or spatial distribution of the virtual canvases 432b-432f is updated within the horizontal spatial arrangement of virtual canvases. For example, as shown in FIG. 4F, ceasing display of the first virtual canvas 432a when the third user leaves the multi-user communication session causes the third virtual canvas 432c that was previously displayed in the second row 433b of the horizontal spatial arrangement to be transitioned/moved to the first row 433a of the horizontal spatial arrangement (e.g., replacing the first virtual canvas 432a in the first row 433a). Particularly, in the example of FIG. 4F, the third user leaving the multi-user communication session results in the fifth user (e.g., represented by the third virtual canvas 432c) to be assigned a prioritization value that is and/or results in the prioritization value already assigned to the fifth user being among the four highest prioritization values according to the updated prioritization data. Accordingly, as similarly discussed above, the first electronic device 101a and the second electronic device 101b optionally update display of the order or spatial distribution of the virtual canvases 432b-432f such that the third virtual canvas 432c is moved from the second row 433b to the first row 433a within the horizontal spatial arrangement in the three-dimensional environment 450A/450B.

As mentioned above, in some examples, detecting a change in the prioritization data includes and/or is based on an indication that a number of remote users in the multi-user communication session has changed, such as the number of participants increasing in the multi-user communication session. For example, in FIG. 4G, the first electronic device 101a detects an input provided by the first user 402 corresponding to a request to add a remote user to the multi-user communication session. In some examples, as shown in FIG. 4G, the first electronic device 101a is displaying user interface 430 associated with the multi-user communication session in the three-dimensional environment 450A. In some examples, the user interface 430 includes a plurality of representations 431a-431f that is selectable to initiate a process to add respective users corresponding to the selected representations to the multi-user communication session. In some examples, the users associated with the plurality of representations 431a-431f correspond to contacts associated with a contacts or phone application running on the first electronic device 101a (and/or the second electronic device 101b). As shown in FIG. 4G, while displaying the user interface 430, the first electronic device 101a detects an air pinch gesture performed by hand 403 of the first user 402, optionally while gaze 426 of the first user 402 is directed to the representation 431f in the user interface 430. In some examples, the representation 431f is associated with a ninth user (e.g., Debbie) of a ninth electronic device that is non-collocated with the first electronic device 101a and the second electronic device 101b in the physical environment 400. It should be understood that additional or alternative inputs are possible, such as air tap gestures, gaze and dwell inputs, verbal commands, controller inputs, etc.

In some examples, in response to detecting the selection of the representation 431f in the user interface 430, the first electronic device 101a transmits a request to the ninth electronic device (e.g., associated with the ninth user Debbie) corresponding to an invitation to join the multi-user communication session. In some examples, after the request has been transmitted to the ninth electronic device, and prior to receiving a response to the invitation to join the multi-user communication session from the ninth electronic device, the first electronic device 101a and the second electronic device 101b update display of the virtual canvases in the three-dimensional environment 450A/450B to include a “waiting” canvas while the response to the invitation is pending. For example, as shown in FIG. 4H, the first electronic device 101a and the second electronic device 101b display seventh virtual canvas 432g representing the ninth user Debbie in the three-dimensional environment 450A/450B. Particularly, in some examples, as shown in FIG. 4H, the seventh virtual canvas 432g represents a placeholder for the virtual canvas that will ultimately be displayed in the three-dimensional environment 450A/450B if and/or when the ninth electronic device joins the multi-user communication session. In some examples, the seventh virtual canvas 432g includes an indication that the response to the invitation is pending. For example, as shown in FIG. 4H, the seventh virtual canvas 432g includes three dots or circles (e.g., displayed below the image (e.g., icon including initials) corresponding to the ninth user Debbie). Additionally, in some examples, as shown in FIG. 4H, when the seventh virtual canvas 432g is displayed in the three-dimensional environment 450A/450B, the seventh virtual canvas 432g is defaulted to being positioned within a lowest priority position within the horizontal spatial arrangement in the three-dimensional environment 450A/450B. For example, as shown in FIG. 4H, the ninth user Debbie has been assigned the lowest prioritization value (e.g., as a default, optionally because no user activity data is available and/or has been transmitted by the ninth electronic device), which causes the seventh virtual canvas 432g to have the lowest priority within the prioritization order, as visually represented by the seventh virtual canvas 432g being displayed at the rightmost position in the second row 433b in the three-dimensional environment 450A/450B. In some examples, the waiting virtual canvas that corresponds to the seventh virtual canvas 432g is displayed for a threshold amount of time in the three-dimensional environment 450A/450B if no response to the invitation is received from the ninth electronic device. For example, the first electronic device 101a and the second electronic device 101b display the seventh virtual canvas 432g for 20, 25, 30, 40, 45, 60, 70, or 90 seconds in the three-dimensional environment 450A/450B, and if no response is received from the ninth electronic device during this period, the first electronic device 101a and the second electronic device 101b cease display of the seventh virtual canvas 432g in the three-dimensional environment 450A/450B.

From FIG. 4H to FIG. 4I, the first electronic device 101a and the second electronic device 101b detect a response to the invitation transmitted to the ninth electronic device associated with the ninth user Debbie for joining the multi-user communication session. Particularly, in FIG. 4I, the first electronic device 101a and the second electronic device 101b detect an indication that the ninth electronic device has accepted the invitation, which causes the ninth electronic device to be added to the multi-user communication session, thereby increasing the total number of participants in the multi-user communication session. In some examples, as illustrated in FIG. 4I, when the ninth electronic device is added to the multi-user communication session, the first electronic device 101a and the second electronic device 101b update display of the seventh virtual canvas 432g in the three-dimensional environment 450A/450B to indicate that the ninth user is now active in the multi-user communication session. For example, as shown in FIG. 4I, the seventh virtual canvas 432g no longer includes the three dots or circles illustrated previously in FIG. 4H. In FIG. 4I, because the user activity of the ninth user in the multi-user communication session has not surpassed that of other remote users in the multi-user communication session (e.g., and/or has not specifically surpassed the user activity of the remote users that have been assigned the four highest prioritization values, as similarly discussed above), the first electronic device 101a and the second electronic device 101b maintain display of the seventh virtual canvas 432g at the rightmost position in the second row 433b within the horizontal spatial arrangement in the three-dimensional environment 450A/450B.

In some examples, as similarly discussed above, the horizontal spatial arrangement of virtual canvases includes and/or is associated with a predefined number of positions within the two rows 433a and 433b. For example, in FIG. 4I, the first row 433a of the horizontal spatial arrangement includes four predefined positions at which virtual canvases can be displayed in the three-dimensional environment 450A/450B, and the second row 433b of the horizontal spatial arrangement includes two predefined positions at which virtual canvases can be displayed in the three-dimensional environment 450A/450B. However, in some examples, the number of remote users in the multi-user communication session may exceed the six predefined positions illustrated in the horizontal spatial arrangement of virtual canvases. Accordingly, in some such examples, not every virtual canvas representing a remote user in the multi-user communication session is displayed or visible at the same in the multi-user communication session. For example, in FIG. 4I, the multi-user communication session includes more than six remote users, but because there are six predefined positions at which the virtual canvases corresponding to the six users are displayed in the three-dimensional environment 450A/450B, one or more virtual canvases representing respective remote users are not currently displayed or visible in the three-dimensional environment 450A/450B. Thus, in some examples, such as when the number of remote users exceeds the number of predefined display positions for the virtual canvases within a respective spatial arrangement in the three-dimensional environment 450A/450B, user input may be provided to display additional and/or alternative virtual canvases corresponding to remote users participating in the multi-user communication session in the three-dimensional environment 450A/450B, as discussed below.

In some examples, as shown in FIG. 4I, the first electronic device 101a detects an input provided by the first user 402 corresponding to a request to scroll the second row 433b in the three-dimensional environment 450A. For example, as shown in FIG. 4I, the first electronic device 101a detects an air pinch gesture performed by the hand 403 of the first user 402, followed by movement of the hand in space (e.g., leftward relative to the viewpoint of the first electronic device 101a), optionally while the gaze 426 of the first user 402 is directed to the seventh virtual canvas 432g in the second row 433b in the three-dimensional environment 450A. In some examples, the second row 433b of the horizontal spatial arrangement is scrollable (e.g., horizontally) in response to user input while the first row 433a is not scrollable (e.g., horizontally). For example, as previously discussed above, the four positions in the first row 433a of the horizontal spatial arrangement are reserved for the virtual canvases representing remote users who are associated with the four highest prioritization values according to the prioritization data, which are therefore greater than the prioritization values assigned to the remote users whose virtual canvases are displayed in the second row 433b of the horizontal spatial arrangement. Accordingly, the virtual canvases that are not currently displayed or visible in FIG. 4I correspond to remote users who have been assigned prioritization values that are lower than the four highest prioritization values, indicating that the virtual canvases that are not currently displayed or visible have been grouped into the second row 433b of the horizontal spatial arrangement.

In some examples, as shown in FIG. 4J, in response to detecting the input corresponding to the request to scroll the second row 433b in the three-dimensional environment 450A, the first electronic device 101a scrolls the second row 433b of the horizontal spatial arrangement in the three-dimensional environment 450A. For example, as shown in FIG. 4J, the first electronic device 101a scrolls the second row 433b leftward relative to the viewpoint of the first electronic device 101a to reveal, in the second row 433b, an eighth virtual canvas 432h representing a tenth user in the multi-user communication session and a ninth virtual canvas 432i representing an eleventh user in the multi-user communication session, both of whom are remote users as previously discussed herein. In some examples, as previously discussed above, because the second row 433b includes two predefined positions at which virtual canvases are displayed, the first electronic device 101a ceases display of the sixth virtual canvas 432f and the seventh virtual canvas 432g in the three-dimensional environment 450A when the second row 433b is scrolled. In some examples, a magnitude (e.g., of speed and/or distance) of the scrolling of the second row 433b in the three-dimensional environment 450B is based on (e.g., is proportional to) and/or corresponds to a magnitude (e.g., of speed and/or distance) of the movement of the hand 403 of the first user 402 discussed above.

In some examples, the scrolling of the second row 433b at the first electronic device 101a discussed above constitutes an event that causes the order or spatial distribution of the virtual canvases in the horizontal spatial arrangement to be updated in the three-dimensional environment 450A (e.g., because the virtual canvases 432f and 432g have been replaced with the virtual canvases 432h and 432i in FIG. 4J). Accordingly, in some examples, to maintain the visual consistency of the order or spatial distribution of the virtual canvases corresponding to the remote users in the multi-user communication session between the first electronic device 101a and the second electronic device 101b, when the second row 433b is scrolled in the three-dimensional environment 450A in the manner discussed above, the first electronic device 101a transmits a signal or other data (e.g., including instructions) indicating to the second electronic device 101b that the second row 433b has been scrolled to reveal the virtual canvases 432h and 432i. In some examples, as shown in FIG. 4J, in response to receiving the signal or data from the first electronic device 101a, the second electronic device 101b updates the order or spatial distribution of the virtual canvases displayed in the three-dimensional environment 450B. Particularly, as shown in FIG. 4J, in accordance with the input detected at the first electronic device 101a, the second electronic device 101b replaces display of the virtual canvases 432f and 432g in the second row 433b of the horizontal spatial arrangement with the virtual canvases 432h and 432i, thereby maintaining the visual consistency of the virtual canvases in the three-dimensional environment 450B for the second user 404 at the second electronic device 101b.

Attention is now directed toward examples of determining placement locations for transitioning display of a visual representation of a remote user from a (e.g., two-dimensional) virtual canvas to a (e.g., three-dimensional) avatar in a three-dimensional environment within a multi-user communication session that includes local and remote users and electronic devices.

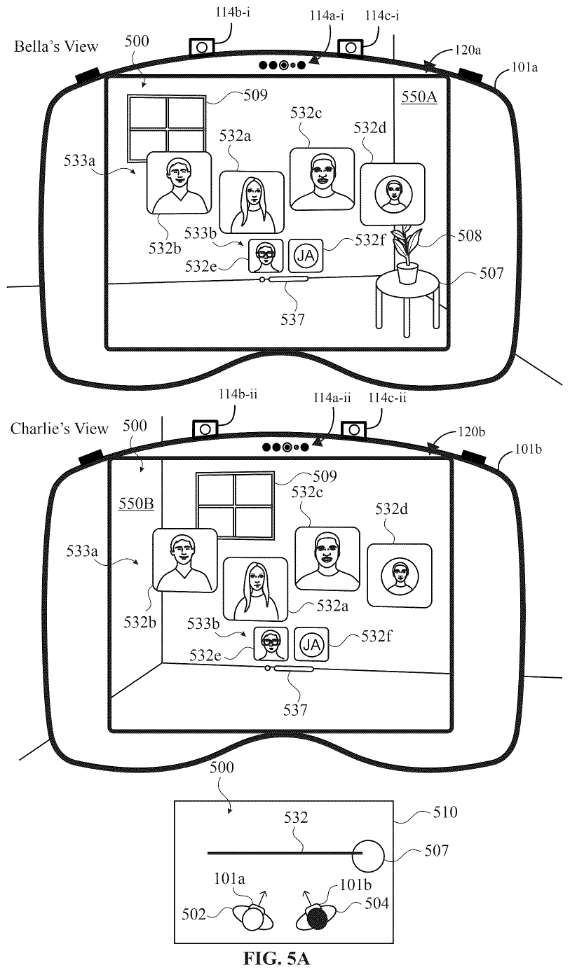

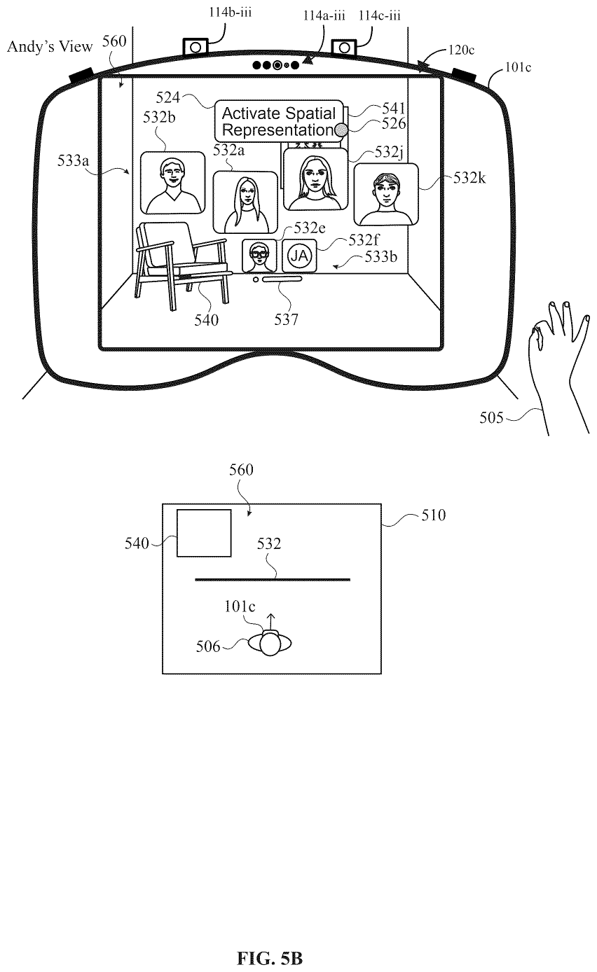

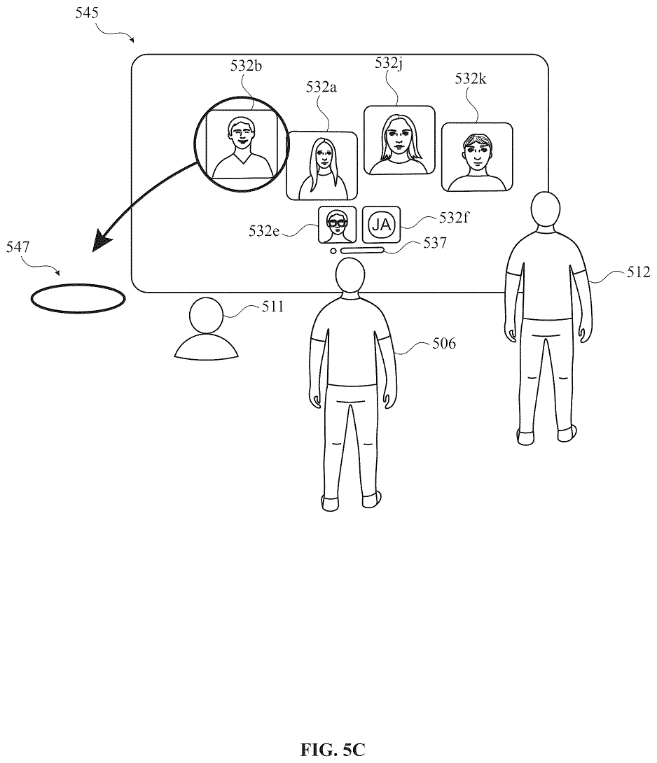

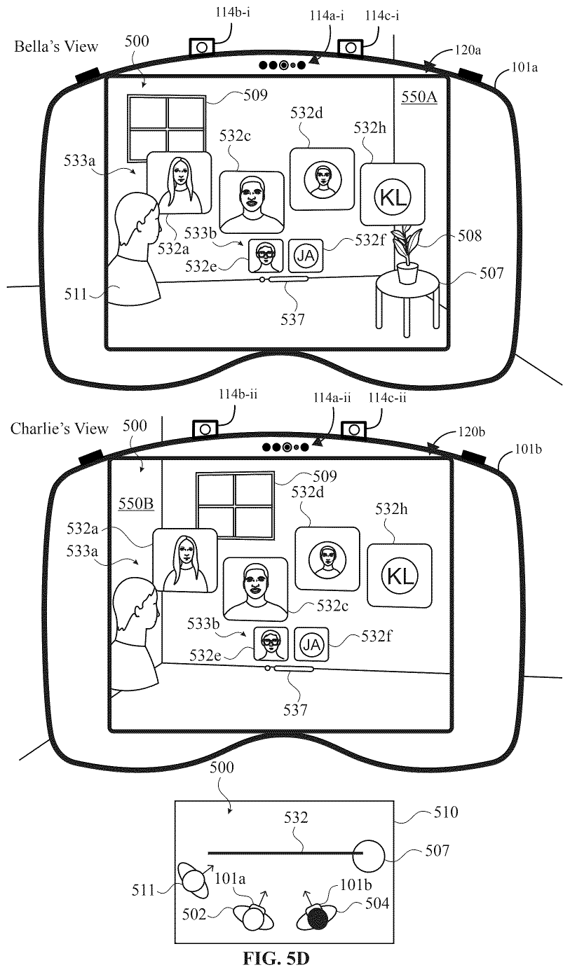

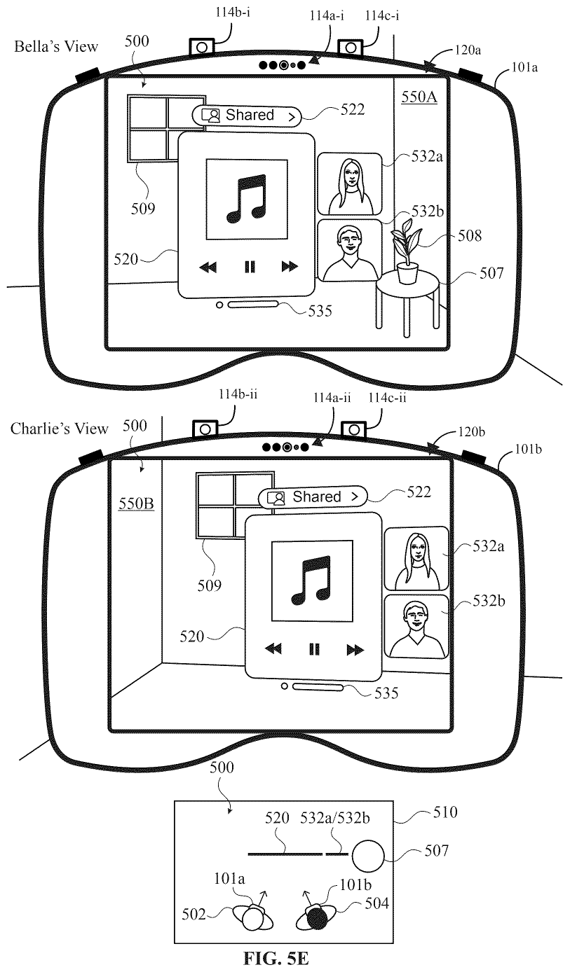

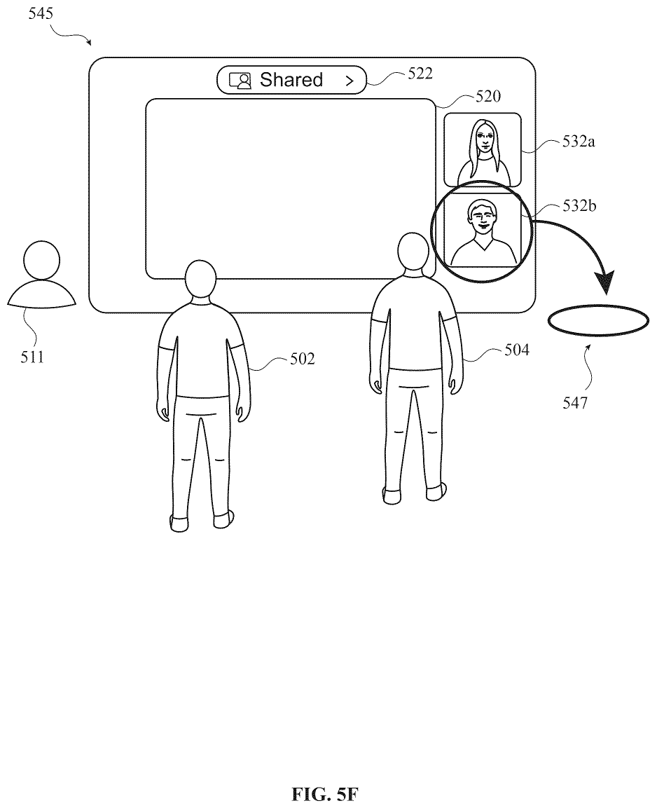

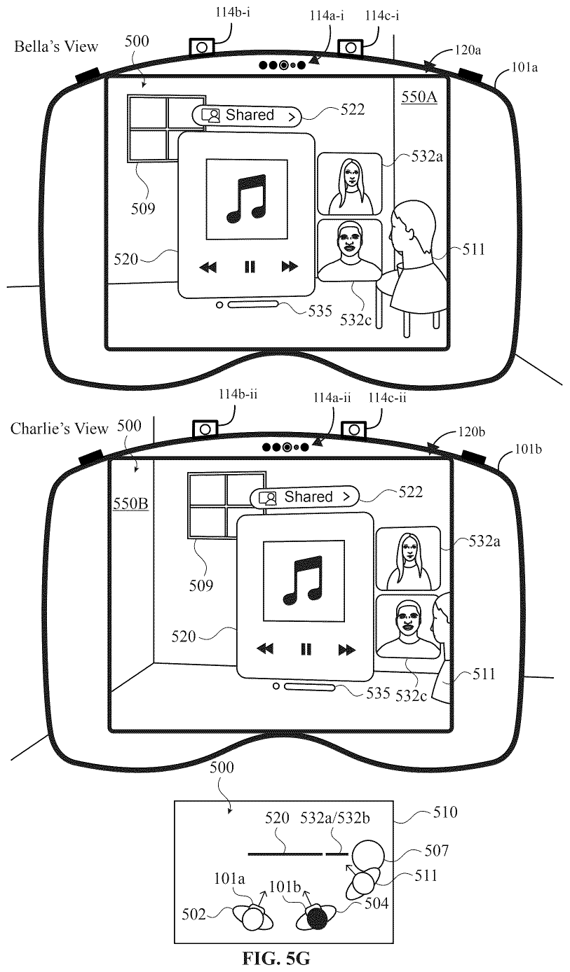

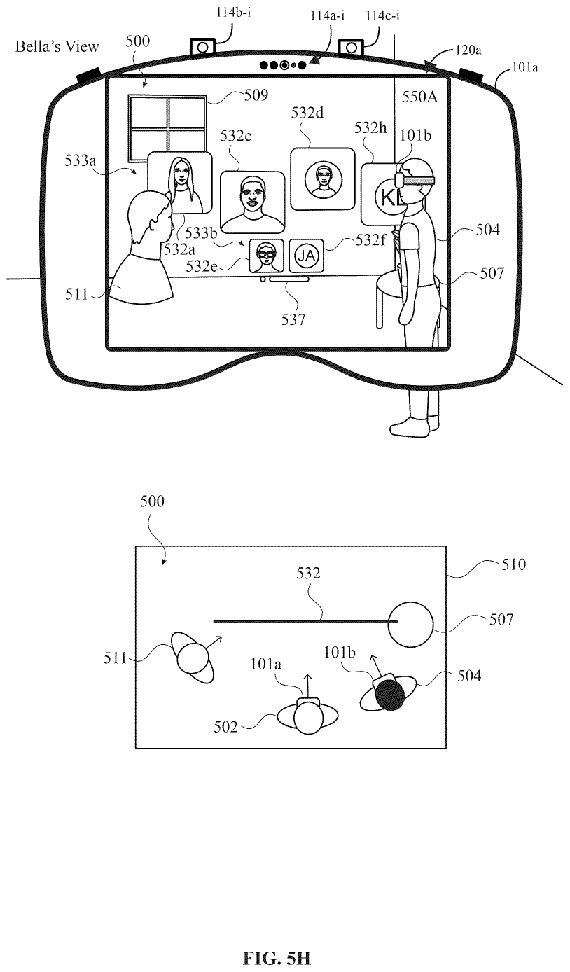

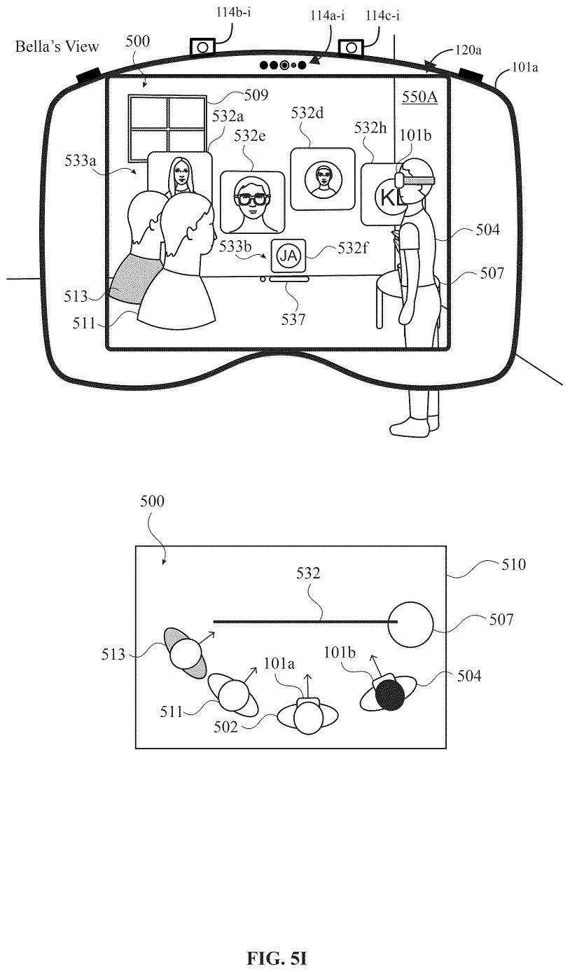

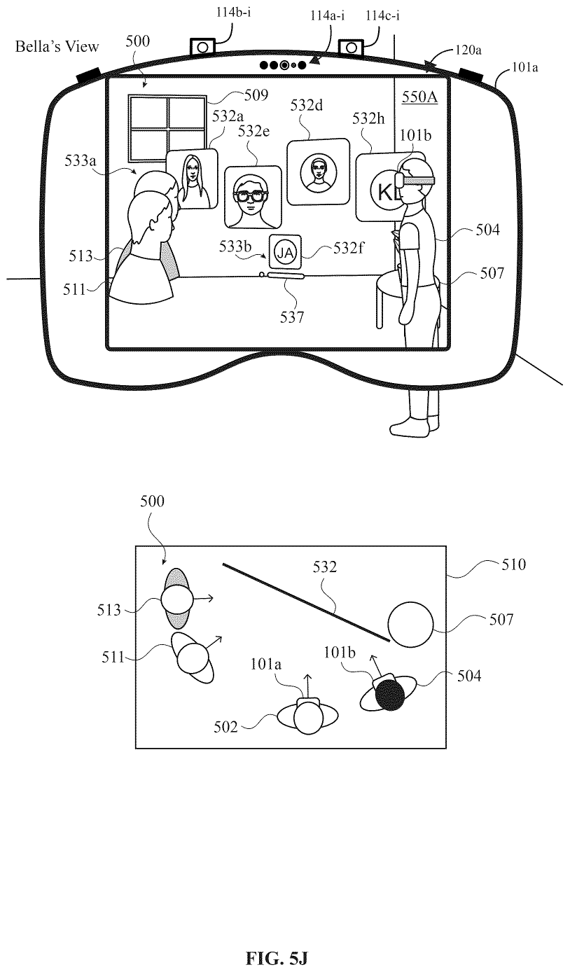

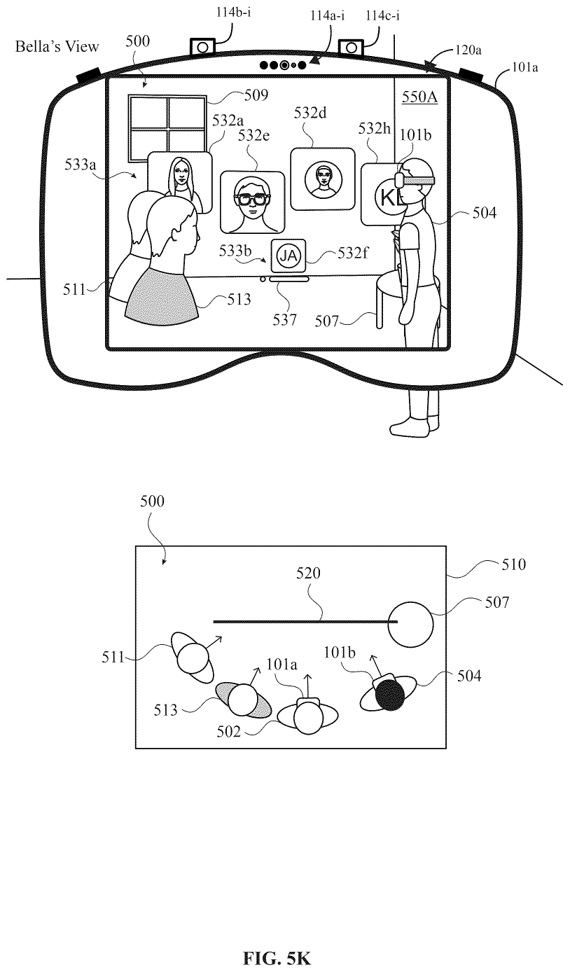

FIGS. 5A-5K illustrate examples of transitioning display of a visual representation of a remote user from a virtual canvas to a three-dimensional avatar in a three-dimensional environment within a multi-user communication session that includes collocated and non-collocated users according to some examples of the disclosure. In FIG. 5A, first electronic device 101a (e.g., associated with first respective user 502) and second electronic device 101b (e.g., associated with second respective user 504) are collocated in physical environment 500, as similarly discussed above, while engaging in a multi-user communication session. In some examples, the first respective user 502 and the second respective user 504 correspond to first user 402 and second user 404, respectively, of FIGS. 4A-4J. In some examples, the physical environment 500 has one or more characteristics of physical environment 400 discussed above.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment 500 of the first electronic device 101a from the viewpoint of the first electronic device 101a. For example, as shown in overhead view 510 in FIG. 5A, the physical environment 500 corresponds to a room that includes window 509, stand 507 and a houseplant 508. Accordingly, as shown in FIG. 5A, the three-dimensional environment 550A presented using the first electronic device 101a includes representations of the window 509, the stand 507 and the houseplant 508 (e.g., the window 509, the stand 507, and the houseplant 508 are visible in a field of view of the first electronic device 101a). Additionally, as shown in FIG. 5A, the second electronic device 101b is presenting (e.g., via display 120b) three-dimensional environment 550B. In FIG. 5A, as similarly discussed above, the three-dimensional environment 550B includes representations (e.g., passthrough representations or computer-generated representations) of the physical environment 500 of the second electronic device 101b from the viewpoint of the second electronic device 101b. For example, as shown in FIG. 5A, the three-dimensional environment 550B presented using the second electronic device 101b includes a representation of the window 509 (e.g., the window 509 is visible in a field of view of the second electronic device 101b). In some examples, the three-dimensional environment 550A/550B has one or more characteristics of three-dimensional environment 450A/450B discussed above.

Additionally, in some examples, as shown in FIG. 5A, the first respective user 502 and the second respective user 504 are participating in the multi-user communication session with a plurality of remote users (e.g., non-collocated users and electronic devices), as previously described herein. Accordingly, in FIG. 5A, the first electronic device 101a and the second electronic device 101b are displaying a plurality of visual representations corresponding to the plurality of remote users in the three-dimensional environment 550A/550B. Particularly, in some examples, as shown in FIG. 5A, the first electronic device 101a and the second electronic device 101b are displaying a plurality of virtual canvases 532 representing the plurality of remote users in the multi-user communication session. In some examples, as similarly discussed above, because the three-dimensional environment 550A/550B does not include a shared virtual object in the multi-user communication session, the plurality of virtual canvases 532 is arranged within a horizontal spatial arrangement (e.g., relative to grabber bar 537) in the three-dimensional environment 550A/550B from the viewpoints of the first electronic device 101a and the second electronic device 101b. In some examples, as previously discussed herein, the horizontal spatial arrangement of virtual canvases includes two rows 533a and 533b in which the virtual canvases are positioned in the three-dimensional environment 550A/550B. For example, as shown in FIG. 5A, virtual canvases 532a-532d are displayed in the first row 533a of the horizontal spatial arrangement and virtual canvases 532e and 532f are displayed in the second row 533b of the horizontal spatial arrangement in the three-dimensional environment 550A/550B. In some examples, the horizontal spatial arrangement has one or more characteristics of the horizontal spatial arrangement of virtual canvases described above with reference to FIGS. 4A-4J. In some examples, as similarly described herein, the virtual canvases 532a-532f correspond to different remote users in the multi-user communication session. In some examples, the virtual canvases 532a-532f correspond to virtual canvases 432a-432f discussed previously above.

FIG. 5B illustrates third electronic device 101c displaying a three-dimensional environment from a viewpoint of the third electronic device 101c. In some examples, the third electronic device is associated with a third respective user 506 (e.g., Andy) who is located in physical environment 560, which is different from (e.g., separate from) the physical environment 500 discussed above in which the first electronic device 101a and the second electronic device 101b are located. In some examples, the third electronic device 101c is in the multi-user communication session that includes the first electronic device 101a and the second electronic device 101b. For example, the third respective user 506 is among the plurality of remote users represented by the plurality of virtual canvases 532 displayed at the first electronic device 101a and the second electronic device 101b. Particularly, in some examples, the third respective user 506 of the third electronic device 101c is visually represented by virtual canvas 532b in the three-dimensional environment 550A/550B at the first electronic device 101a and the second electronic device 101b.

As shown in FIG. 5B, the third electronic device 101c is presenting (e.g., via display 120c) a three-dimensional environment that includes representations (e.g., passthrough representations or computer-generated representations) of the physical environment 560 of the third electronic device 101c from the viewpoint of the third electronic device 101c. For example, as shown in overhead view 510 in FIG. 5B, the physical environment 560 corresponds to a room that includes chair 540 and painting 541. Accordingly, as shown in FIG. 5B, the three-dimensional environment presented using the third electronic device 101c includes representations of the chair 540 and the painting 541 (e.g., the chair 540 and the painting 541 are visible in a field of view of the third electronic device 101c). Additionally, as shown in FIG. 5B, the third electronic device 101c is presenting a plurality of visual representations of a plurality of users in the multi-user communication session in the three-dimensional environment. In FIG. 5B, because the third respective user 506 is not collocated with any other users in the multi-user communication session in the physical environment 560, the other users, including the first respective user 502 and the second respective user 504, correspond to remote users relative to the third respective user 506 at the third electronic device 101c. Accordingly, as shown in FIG. 5B, the third electronic device 101c is optionally displaying a plurality of virtual canvases 532 for the users in the multi-user communication session that are remote relative to the third respective user 506 of the third electronic device 101c, including virtual canvas 532j corresponding to the first respective user 502 of the first electronic device 101a and virtual canvas 532k corresponding to the second respective user 504 of the second electronic device 101b. In some examples, as similarly discussed above, the plurality of virtual canvases 532 displayed at the third electronic device 101c is arranged in a horizontal spatial arrangement that includes the first row 533a and the second row 533b in the three-dimensional environment from the viewpoint of the third electronic device 101c. In some examples, as similarly discussed above, because the third respective user 506 is not located in the same physical environment as the first respective user 502 and the second respective user 504, visual consistency of the virtual canvases is not maintained among the first electronic device 101a, the second electronic device 101b, and the third electronic device 101c, as illustrated between FIG. 5A and FIG. 5B. For example, the order or spatial distribution of the virtual canvases and/or the specific virtual canvases displayed at the third electronic device 101c is different from those at the first electronic device 101a and the second electronic device 101b.

As shown in FIG. 5B, the third electronic device 101c is displaying selectable option 524 that is associated with a spatial state of the third respective user 506 in the multi-user communication session. For example, a respective user may be associated with either a first spatial state indicating that the respective user is to be visually represented and is to participate in the multi-user communication session spatially (e.g., via a three-dimensional avatar) or a second spatial state indicating that the respective user is to be visually represented and is to participate in the multi-user communication session non-spatially (e.g., via a two-dimensional representation). In some examples, participating in a multi-user communication session spatially (e.g., in the first spatial state) indicates that a respective user experiences spatial truth (e.g., as defined herein above) with other users in the multi-user communication session who are also participating spatially. For example, in FIG. 5A, the first respective user 502 of the first electronic device 101a and the second respective user 504 of the second electronic device 101b are participating in the multi-user communication session spatially (e.g., in the first spatial state) and thus experience spatial truth with one another, while the plurality of remote users, including the third respective user 506, represented by the virtual canvases 532a-532f are participating in the multi-user communication session non-spatially and thus do not experience spatial truth with the first respective user 502 and the second respective user 504 (e.g., and do not experience spatial truth with each other).

In FIG. 5B, because the third respective user 506 is currently participating in the multi-user communication session non-spatially, the third respective user 506 is currently visually represented in the three-dimensional environment 550A/550B at the first electronic device 101a and the second electronic device 101b as a two-dimensional representation, as shown in FIG. 5A. For example, as described above, the third respective user 506 is being visually represented as the virtual canvas 532b at the first electronic device 101a and the second electronic device 101b. In some examples, a remote user who is currently associated with the second spatial state (e.g., is participating in the multi-user communication session non-spatially) is able to provide input for transitioning from the second spatial state to the first spatial state, such as via the selectable option 524. For example, in FIG. 5B, the selectable option 524 is selectable to transition the third respective user 506 from being visually represented as a non-spatial representation (e.g., the two-dimensional virtual canvas 532c) to a spatial representation (e.g., a three-dimensional avatar), thereby enabling the third respective user 506 to participate spatially in the multi-user communication session and experience spatial truth with the first respective user 502 and the second respective user 504 (e.g., via their respective electronic devices as similarly discussed above).

In FIG. 5B, while displaying the selectable option 524, the third electronic device 101c detects a selection of the selectable option 524. For example, as shown in FIG. 5B, the third electronic device 101c detects an air pinch gesture (or similar input) provided by hand 505 of the third respective user 506, optionally while gaze 526 of the third respective user 506 is directed to the selectable option 524. In some examples, the third electronic device 101c is displaying the selectable option 524 after having received input provided by the third respective user 506 corresponding to a request to display the selectable option 524, such as within a settings user interface or other menu associated with the multi-user communication session.

In some examples, in response to detecting the selection of the selectable option 524, the third electronic device 101c associates the third respective user 506 with the first spatial state described above. For example, the third electronic device 101c initiates a process to transition the display of the visual representation of the third respective user 506 (e.g., at the other electronic devices in the multi-user communication session) from being a non-spatial representation to a spatial representation, as described in more detail below. In some examples, the third electronic device 101c transmits a signal or other data (e.g., including instructions) to the electronic devices in the multi-user communication session, including the first electronic device 101a and the second electronic device 101b, that causes the electronic devices to update display of the visual representation of the third respective user 506 from being a non-spatial representation (e.g., the virtual canvas 532b) to a spatial representation (e.g., a three-dimensional avatar).

FIG. 5C illustrates an exemplary diagram 545 illustrating a process for transitioning display of a visual representation of a remote user from a non-spatial representation to a spatial representation within a multi-user communication session. As shown in FIG. 5C, a plurality of users of a plurality of electronic devices is engaging in a multi-user communication session, including a first respective user 506, a second respective user 512, and a third respective user that is represented by avatar 511. In some examples, the first respective user 506 and the second respective user 512 are collocated in a respective physical environment, while the third respective user represented by the avatar 511 is non-collocated with the first respective user 506 and the second respective user 512 in the respective physical environment. In FIG. 5C, because the third respective user is visually represented by the avatar 511 (e.g., a spatial representation), the third respective user experiences spatial truth with the first respective user 506 and the second respective user 512 (e.g., via their respective electronic devices).

Additionally, as shown in FIG. 5C, the multi-user communication session includes a plurality of remote users who are currently participating non-spatially in the multi-user communication session. For example, as shown in FIG. 5C and as similarly discussed above, the plurality of remote users is represented via virtual canvases 532a-532k, which correspond to non-spatial representations within the multi-user communication session. As similarly mentioned above with reference to FIG. 5B, a respective remote user is able to transition from participating in the multi-user communication session non-spatially to participating spatially, which includes updating presentation of their respective visual representation in the three-dimensional environments of the users who are also participating in the multi-user communication session as a spatial participant (e.g., the first respective user 506, the second respective user 512, and the third respective user). For example, the respective remote user is transitioned from being visually represented as a virtual canvas to being visually represented as a three-dimensional avatar, similar to the avatar 511 in FIG. 5C.

In some examples, in response to detecting an input or other indication (e.g., such as the selection of the selectable option 524 in FIG. 5B), a respective electronic device associated with a respective remote user associates the respective remote user with being a spatial participant (e.g., in the first spatial state described above) in the multi-user communication session, which causes the non-spatial representation of the respective remote user to be redisplayed as a spatial representation at the electronic devices associated with the first respective user 506, the second respective user 512, and the third respective user in FIG. 5C. In some examples, transitioning from displaying a visual representation of a remote user as a non-spatial representation to a spatial representation includes determining a placement location 547 at which to display the spatial representation of the remote user at the electronic devices associated with the first respective user 506, the second respective user 512, and the third respective user, as illustrated in the diagram 545 in FIG. 5C. In some examples, the placement location 547 at which to display the spatial representation of the remote user is determined based on a location of the non-spatial representation of the remote user. For example, in the diagram 545 in FIG. 5C, the remote user represented by the virtual canvas 532b has provided input at their electronic device corresponding to a request to participate in the multi-user communication session as a spatial participant. Accordingly, in FIG. 5C, the electronic devices associated with the first respective user 506, the second respective user 512, and the third respective user initiate a process to transition display of the virtual canvas 532b corresponding to the remote user to a three-dimensional avatar that is displayed at the placement location 547. In some examples, the placement location 547 illustrated in the diagram 545 in FIG. 5C is based on the location of the virtual canvas 532b within the horizontal spatial arrangement of virtual canvases. Particularly, in some examples, the placement location 547 corresponds to a location in the three-dimensional environment that is spatially closest to (e.g., is within a threshold distance of, such as 0.25, 0.5, 0.75, 1, 1.5, 2, 3, 5, 10, etc. meters of) the location of the virtual canvas 532b within the horizontal spatial arrangement of virtual canvases illustrated in FIG. 5C. Further, as described in more detail below, the placement location 547 corresponds to a location in the three-dimensional environment that is unoccupied by another user or spatial representation within the multi-user communication session. For example, as shown in the diagram 545 in FIG. 5C, the placement location 547 is adjacent to and/or in front of the location of the virtual canvas 532b in the three-dimensional environment, while being unoccupied by the avatar 511, the first respective user 506, and the second respective user 512 in the three-dimensional environment.

Thus, in some examples, in response to detecting the selection of the selectable option 524 in FIG. 5B described above, the third electronic device 101c transmits a signal or other data (e.g., including instructions) to the first electronic device 101a and the second electronic device 101b indicating that the third respective user 506 of the third electronic device 101c has transitioned to being a spatial participant in the multi-user communication session. In some examples, in response to receiving the indication from the third electronic device 101c, the first electronic device 101a and the second electronic device 101b determine a placement location in the three-dimensional environment 550A/550B at which to display a spatial representation of the third respective user 506 in the three-dimensional environment 550A/550B. Particularly, as described above with reference to FIG. 5C, the first electronic device 101a and the second electronic device 101b identify a location in the three-dimensional environment 550A/550B that is spatially closest to the position of the virtual canvas 532b within the horizontal spatial arrangement illustrated previously in FIG. 5A. For example, in FIG. 5D, the first electronic device 101a and the second electronic device 101b identify a placement location that is adjacent to and/or in front of the leftmost position (e.g., the position of the virtual canvas 532b in FIG. 5A) of the first row 533a in the horizontal spatial arrangement in the three-dimensional environment 550A/550B, as illustrated in the overhead view 510. Additionally, as illustrated in the overhead view 510 in FIG. 5D, the location in the three-dimensional environment 550A/550B to which the placement location corresponds is unoccupied by the first respective user 502 (e.g., and the first electronic device 101a) and the second respective user 504 (e.g., and the second electronic device 101b). In some examples, as shown in FIG. 5D, following the identification of the placement location in the three-dimensional environment 550A/550B, the first electronic device 101a and the second electronic device 101b display avatar 511 corresponding to the third respective user 506 in the three-dimensional environment 550A/550B, indicating that the third respective user 506 is now participating spatially in the multi-user communication session (e.g., and therefore now experiences spatial truth with the first respective user 502 and the second respective user 504). Additionally, in some examples, as shown in FIG. 5D, when the avatar 511 corresponding to the third respective user 506 is displayed in the three-dimensional environment 550A/550B, the avatar 511 is oriented to face toward the plurality of virtual canvases 532 in the three-dimensional environment 550A/550B.

In some examples, as shown in FIG. 5D, when the avatar 511 is displayed in the three-dimensional environment 550A/550B, the first electronic device 101a and the second electronic device 101b cease display of the non-spatial representation of the third respective user 506 in the three-dimensional environment 550A/550B. For example, as shown in FIG. 5D, the first electronic device 101a and the second electronic device 101b are no longer displaying the virtual canvas 532b when the avatar 511 corresponding to the third respective user 506 is displayed in the three-dimensional environment 550A/550B. Additionally, as similarly discussed above with reference to FIGS. 4A-4J, when the virtual canvas 532b ceases to be displayed in the three-dimensional environment 550A/550B, the first electronic device 101a and the second electronic device 101b update an order or spatial arrangement of the virtual canvases within the horizontal spatial arrangement in the three-dimensional environment 550A/550B. For example, as shown in FIG. 5D, the first electronic device 101a and the second electronic device 101b update the plurality of virtual canvases 532 to include virtual canvas 532h representing a respective remote user which was previously not displayed or visible in the three-dimensional environment 550A/550B (e.g., due to the predefined number of display positions within the horizontal spatial arrangement, as similarly discussed above). Additionally, in some examples, as shown in FIG. 5D, the virtual canvases 532a/532c/532d are shifted to the left within the first row 533a of the horizontal spatial arrangement in the three-dimensional environment 550A/550B from the viewpoints of the first electronic device 101a and the second electronic device 101b (e.g., due to an updating of the prioritization order of the virtual canvases based on a change in the prioritization data caused by the ceasing display of the virtual canvas 532b, as previously described herein).

The above-described manner of transitioning display of a visual representation of a remote user from a non-spatial representation to a spatial representation is similarly applied while the visual representation of the remote user is displayed within a vertical spatial arrangement (e.g., anchored to a shared virtual object) within the multi-user communication session. For example, in FIG. 5E, the first electronic device 101a and the second electronic device 101b are in a multi-user communication session with a plurality of remote users while a shared object (e.g., virtual object 520, as indicated by pill 522) is displayed in the three-dimensional environment 550A/550B. Accordingly, as previously discussed herein, the virtual canvases 532a and 532b representing the plurality of remote users are arranged in a vertical spatial arrangement (e.g., a column) relative to the virtual object 520 in the three-dimensional environment 550A/550B (e.g., anchored to a side or edge of the virtual object 520 from the viewpoints of the first electronic device 101a and the second electronic device 101b. In some examples, the virtual object 520 has one or more characteristics of virtual object 420 described above.

In FIG. 5E, the first electronic device 101a and the second electronic device 101b detect an indication that a respective remote user has provided input at their respective electronic device corresponding to a request to participate in the multi-user communication session spatially, such as input similar to the input described above with reference to FIG. 5B. In the example of FIG. 5E, the remote user who provided the input for transitioning from participating non-spatially to spatially in the multi-user communication session corresponds to the remote user represented by the virtual canvas 532b in the three-dimensional environment 550A/550B. In some examples, as similarly discussed above and as described in more detail below, the indication received from the respective electronic device associated with the remote user represented by the virtual canvas 532b causes the first electronic device 101a and the second electronic device 101b to transition from representing the remote user as the virtual canvas 532b to representing the remote user as a virtual avatar.

FIG. 5F illustrates an exemplary diagram 545 illustrating a process for transitioning display of a visual representation of a remote user from a non-spatial representation to a spatial representation within a multi-user communication session. As shown in FIG. 5F, a plurality of users of a plurality of electronic devices is engaging in a multi-user communication session, including a first respective user 502, a second respective user 504, and a third respective user that is represented by avatar 511. In some examples, the first respective user 502 and the second respective user 504 are collocated in a respective physical environment, while the third respective user represented by the avatar 511 is non-collocated with the first respective user 502 and the second respective user 504 in the respective physical environment. In FIG. 5F, because the third respective user is visually represented by the avatar 511 (e.g., a spatial representation), the third respective user experiences spatial truth with the first respective user 502 and the second respective user 504 (e.g., via their respective electronic devices).

Additionally, as shown in FIG. 5F, the multi-user communication session includes a plurality of remote users who are currently participating non-spatially in the multi-user communication session. For example, as shown in FIG. 5F and as similarly discussed above, the plurality of remote users is represented via virtual canvases 532a and 532b, which correspond to non-spatial representations within the multi-user communication session. In some examples, as illustrated in the diagram 545 in FIG. 5F, because a shared virtual object 520 is presented within the multi-user communication session, the virtual canvases 532a and 532b are spatially arranged within a vertical spatial arrangement (e.g., in a column) that is anchored to the virtual object 520 (e.g., displayed adjacent to an edge or side of the virtual object 520) relative to the viewpoints of the electronic devices associated with the first respective user 502, the second respective user 504, and the third respective user. As similarly mentioned above with reference to FIG. 5B, a respective remote user is able to transition from participating in the multi-user communication session non-spatially to participating spatially, which includes updating presentation of their respective visual representation in the three-dimensional environments of the users who are also participating in the multi-user communication session as a spatial participant (e.g., the first respective user 502, the second respective user 504, and the third respective user). For example, the respective remote user is transitioned from being visually represented as a virtual canvas to being visually represented as a three-dimensional avatar, similar to the avatar 511 in FIG. 5F.

In some examples, in response to detecting an input or other indication (e.g., similar to the selection of the selectable option 524 in FIG. 5B), a respective electronic device associated with a respective remote user associates the respective remote user with being a spatial participant (e.g., in the first spatial state described above) in the multi-user communication session, which causes the non-spatial representation of the respective remote user to be redisplayed as a spatial representation at the electronic devices associated with the first respective user 502, the second respective user 504, and the third respective user in FIG. 5F. In some examples, as similarly described above, transitioning from displaying a visual representation of a remote user as a non-spatial representation to a spatial representation includes determining a placement location 547 at which to display the spatial representation of the remote user at the electronic devices associated with the first respective user 502, the second respective user 504, and the third respective user, as illustrated in the diagram 545 in FIG. 5F. In some examples, the placement location 547 at which to display the spatial representation of the remote user is determined based on a location of the non-spatial representation of the remote user. For example, in the diagram 545 in FIG. 5F, the remote user represented by the virtual canvas 532b has provided input at their electronic device corresponding to a request to participate in the multi-user communication session as a spatial participant. Accordingly, in FIG. 5F, the electronic devices associated with the first respective user 502, the second respective user 504, and the third respective user initiate a process to transition display of the virtual canvas 532b corresponding to the remote user to a three-dimensional avatar that is displayed at the placement location 547. In some examples, the placement location 547 illustrated in the diagram 545 in FIG. 5F is based on the location of the virtual canvas 532b within the vertical spatial arrangement of virtual canvases. Particularly, in some examples, the placement location 547 corresponds to a location in the three-dimensional environment that is spatially closest to (e.g., is within a threshold distance of, such as 0.25, 0.5, 0.75, 1, 1.5, 2, 3, 5, 10, etc. meters of) the location of the virtual canvas 532b within the vertical spatial arrangement of virtual canvases illustrated in FIG. 5F. Further, as described in more detail below, the placement location 547 corresponds to a location in the three-dimensional environment that is unoccupied by another user or spatial representation within the multi-user communication session. For example, as shown in the diagram 545 in FIG. 5F, the placement location 547 is adjacent to and/or in front of the location of the virtual canvas 532b in the three-dimensional environment, while being unoccupied by the avatar 511, the first respective user 502, and the second respective user 504 in the three-dimensional environment.

Thus, in some examples, in response to detecting the indication described above with reference to FIG. 5E that a respective remote user has provided input at their respective electronic device corresponding to a request to participate in the multi-user communication session spatially, the first electronic device 101a and the second electronic device 101b determine a placement location in the three-dimensional environment 550A/550B at which to display a spatial representation of the remote user in the three-dimensional environment 550A/550B. Particularly, as described above with reference to FIG. 5F, the first electronic device 101a and the second electronic device 101b identify a location in the three-dimensional environment 550A/550B that is spatially closest to the position of the virtual canvas 532b within the vertical spatial arrangement illustrated previously in FIG. 5E. For example, in FIG. 5G, the first electronic device 101a and the second electronic device 101b identify a placement location that is adjacent to and/or in front of the bottom position (e.g., the position of the virtual canvas 532b in FIG. 5E) of the column of virtual canvases adjacent to the virtual object 520 in the three-dimensional environment 550A/550B, as illustrated in the overhead view 510. Additionally, as illustrated in the overhead view 510 in FIG. 5G, the location in the three-dimensional environment 550A/550B to which the placement location corresponds is unoccupied by the first respective user 502 (e.g., and the first electronic device 101a) and the second respective user 504 (e.g., and the second electronic device 101b). In some examples, as shown in FIG. 5G, following the identification of the placement location in the three-dimensional environment 550A/550B, the first electronic device 101a and the second electronic device 101b display avatar 511 corresponding to the remote user in the three-dimensional environment 550A/550B, indicating that the remote user is now participating spatially in the multi-user communication session (e.g., and therefore now experiences spatial truth with the first respective user 502 and the second respective user 504). Additionally, in some examples, as shown in FIG. 5G, when the avatar 511 corresponding to the remote user is displayed in the three-dimensional environment 550A/550B, the avatar 511 is oriented to face toward the virtual object 520 in the three-dimensional environment 550A/550B.

In some examples, as shown in FIG. 5G, when the avatar 511 is displayed in the three-dimensional environment 550A/550B, the first electronic device 101a and the second electronic device 101b cease display of the non-spatial representation of the remote user in the three-dimensional environment 550A/550B. For example, as shown in FIG. 5G, the first electronic device 101a and the second electronic device 101b are no longer displaying the virtual canvas 532b when the avatar 511 corresponding to the remote user is displayed in the three-dimensional environment 550A/550B. Additionally, as similarly discussed above with reference to FIGS. 4A-4J, when the virtual canvas 532b ceases to be displayed in the three-dimensional environment 550A/550B, the first electronic device 101a and the second electronic device 101b update an order or spatial arrangement of the virtual canvases within the vertical spatial arrangement in the three-dimensional environment 550A/550B. For example, as shown in FIG. 5G, the first electronic device 101a and the second electronic device 101b update the plurality of virtual canvases 532 to include virtual canvas 532c representing a respective remote user which was previously not displayed or visible in the three-dimensional environment 550A/550B (e.g., due to the predefined number of display positions within the vertical spatial arrangement, as similarly discussed above).

Accordingly, as outlined above, providing systems and methods for transitioning display of a visual representation of a remote user from a non-spatial representation to a spatial representation within a multi-user communication session when the remote user requests to participate in the multi-user communication session spatially based on a location of the non-spatial representation facilitates discovery that the remote user is now experiencing spatial truth with the local users in the multi-user communication session, which enhances the user experience within the multi-user communication session. Additionally, automatically determining a location at which to display the spatial representation of the remote user in a three-dimensional environment based on the prior location of the non-spatial representation of the remote user in the three-dimensional environment reduces a magnitude (e.g., of distance) with which virtual elements (e.g., objects and/or representations) are visually updated relative to the local users and/or reduces the need for user input for manually selecting the placement location, which helps reduce eye strain of the local users and reduces consumption of computing resources associated with responding to such user input, as another benefit.

FIGS. 5H-5K illustrate additional examples of transitioning display of a visual representation of a remote user from a non-spatial representation to a spatial representation within a multi-user communication session. In FIG. 5H, first electronic device 101a (e.g., associated with first respective user 502) is collocated with second electronic device 101b (e.g., associated with second respective user 504) in the physical environment 500, as illustrated in the overhead view 510. Additionally, in some examples, as shown in FIG. 5H, the first electronic device 101a and the second electronic device 101b are participating in the multi-user communication session with a plurality of remote users, including a third respective user of a third electronic device represented by avatar 511 in the three-dimensional environment 550A presented at the first electronic device 101a. In some examples, as similarly described above, because the third respective user of the third electronic device is visually represented as the avatar 511 (e.g., a spatial representation) in the three-dimensional environment 550A, the first respective user 502 of the first electronic device 101a and the second respective user 504 of the second electronic device 101b are experiencing spatial truth with the third user within the multi-user communication session. Further, as shown in FIG. 5H, the plurality of remote users includes non-spatial participants which are represented by virtual canvases in the three-dimensional environment 550A. In some examples, as previously discussed herein, because the three-dimensional environment 550A does not include a virtual object that is shared within the multi-user communication session (e.g., such as virtual object 520 described above), the virtual canvases are arranged within a horizontal spatial arrangement that includes the two rows 533a and 533b in the three-dimensional environment 550A.

In FIG. 5H, the first electronic device 101a (e.g., and the second electronic device 101b) detects an indication that a respective remote user has provided input at their respective electronic device corresponding to a request to participate in the multi-user communication session spatially, such as input similar to the input described above with reference to FIG. 5B. In the example of FIG. 5H, the remote user who provided the input for transitioning from participating non-spatially to spatially in the multi-user communication session corresponds to the remote user represented by the virtual canvas 532c in the three-dimensional environment 550A (e.g., a fourth user of a fourth electronic device). In some examples, as similarly discussed above and as described in more detail below, the indication received from the respective electronic device associated with the remote user (e.g., the fourth user) represented by the virtual canvas 532c causes the first electronic device 101a (e.g., and the second electronic device 101b) to transition from representing the remote user as the virtual canvas 532c to representing the remote user as a virtual avatar (e.g., similar to the avatar 511 in FIG. 5H).

In some examples, as previously described herein with reference to FIG. 5C, transitioning the display of the visual representation of the remote user (e.g., the fourth user) from the virtual canvas 532c to a virtual avatar (e.g., a spatial representation) includes identifying a placement location for the avatar in the three-dimensional environment 550A. Particularly, as previously described herein, the first electronic device 101a (e.g., and the second electronic device 101b) identify a location in the three-dimensional environment 550A that is spatially closest to the position of the virtual canvas 532c within the first row 533a of the horizontal spatial arrangement in the three-dimensional environment 550A. However, in some instances, the identified placement location for the avatar corresponding to the remote user in the three-dimensional environment 550A may be occupied by another user, virtual object, or physical object of the physical environment 500. For example, as illustrated in the overhead view 510 in FIG. 5H, the location in the three-dimensional environment 550A that is closest to (e.g., in front of and/or adjacent to) the position of the virtual canvas 532c within the first row 533a of the horizontal spatial arrangement in the three-dimensional environment 550A is currently occupied by the avatar 511. Accordingly, as discussed below, the first electronic device 101a (e.g., and the second electronic device 101b) identifies an alternative (e.g., a different) placement location in the three-dimensional environment 550A, which optionally includes updating display of one or more virtual object or elements in the three-dimensional environment 550A from the viewpoint of the first electronic device 101a.

In some examples, as shown in FIG. 5I, determining the alternative placement location for the avatar corresponding to the remote user in the three-dimensional environment 550A includes updating display of one or more other avatars corresponding to one or more other remote users in the three-dimensional environment 550A to enable the avatar corresponding to the remote user to be displayed at a location in the three-dimensional environment 550A that is closest to the position of the virtual canvas 532c within the first row 533a of the horizontal spatial arrangement in the three-dimensional environment 550A. For example, as previously discussed above and as illustrated in the overhead view 510 in FIG. 5K, the (e.g., ideal) placement location that is closest to the position of the virtual canvas 532c within the first row 533a of the horizontal spatial arrangement in the three-dimensional environment 550A corresponds to the location that is currently occupied by the avatar 511 in the three-dimensional environment 550A. In some such examples, because the avatar 511 is a virtual representation (e.g., despite representing the third respective user who is participating spatially in the multi-user communication session) within the three-dimensional environment 550A, the location of the avatar 511 within the three-dimensional environment 550A is able to be freely and easily updated relative to the viewpoint of the first electronic device 101a (e.g., and the viewpoint of the second electronic device 101b). More specifically, in some examples, the avatar 511 is able to be repositioned in the three-dimensional environment 550A from the viewpoint of the first electronic device 101a to accommodate the display of the avatar 513 in the three-dimensional environment 550A, whereas local users (e.g., the second respective user 504 of the second electronic device 101b) and physical objects (e.g., stand 507 and/or houseplant 508) are not freely and easily movable in the three-dimensional environment 550A (e.g., because the local users and physical objects do not correspond to virtual objects that are generated and displayed by the first electronic device 101a). Accordingly, in some examples, as shown in FIG. 5I, the first electronic device 101a (e.g., and the second electronic device 101b) reposition the avatar 511 corresponding to the third respective user, as shown in the overhead view 510, toward the first respective user 502, such that the avatar 511 is now located adjacent to the second respective user 504 relative to the viewpoint of the first electronic device 101a in the three-dimensional environment 550A, thereby causing the previously identified placement location for the avatar corresponding to the fourth user discussed above to be unoccupied in the three-dimensional environment 550A. In some examples, as shown in the overhead view 510 in FIG. 5I, when the avatar 511 is repositioned in the three-dimensional environment 550A relative to the viewpoint of the first electronic device 101a (e.g., and the viewpoint of the second electronic device 101b), the avatar 511 is displayed with an orientation that causes the avatar 511 to continue to face toward the plurality of virtual canvases 532 in the three-dimensional environment 550A from the updated position of the avatar 511 in the three-dimensional environment 550A.

In some examples, as shown in FIG. 5I, following the repositioning of the avatar 511 corresponding to the third respective user in the three-dimensional environment 550A, the first electronic device 101a (e.g., and the second electronic device 101b) displays avatar 513 corresponding to the fourth user at the previously identified placement location in the three-dimensional environment 550A, indicating that the fourth user is now participating spatially in the multi-user communication session. For example, as shown in the overhead view 510 in FIG. 5I, the avatar 513 is displayed at the location in the three-dimensional environment 550A that was previously occupied by the avatar 511 (e.g., the location of the avatar 511 in FIG. 5H, prior to the movement of the avatar 511) in the three-dimensional environment 550A from the viewpoint of the first electronic device 101a. Additionally, in some examples, as indicated in the overhead view 510 in FIG. 5I, the avatar 513 is displayed with an orientation that faces toward the plurality of virtual canvases 532 in the three-dimensional environment 550A, as similarly discussed above. In some examples, as previously described herein and as illustrated in FIG. 5I, when the avatar 513 is displayed in the three-dimensional environment 550A, the first electronic device 101a (e.g., and the second electronic device 101b) updates an order or spatial distribution of the virtual canvases within the horizontal spatial arrangement in the three-dimensional environment 550 based on ceasing display of the virtual canvas 532c corresponding to the fourth user in the three-dimensional environment 550A. For example, as shown in FIG. 5I, after the virtual canvas 532c ceases to be displayed in the three-dimensional environment 550A, virtual canvas 532e representing a respective remote user is moved and/or transitioned to the position of the virtual canvas 532c within the first row 533a. Particularly, as shown, the virtual canvas 532e is moved from the second row 533b to the first row 533a within the horizontal spatial arrangement in accordance with the updated prioritization order of the virtual canvases that is updated based on the updated prioritization data following the transition of the display of the visual representation of the fourth user from the virtual canvas 532c to the avatar 513 in the three-dimensional environment 550A, as previously described herein.

Alternatively, in some examples, as shown in FIG. 5J, determining the alternative placement location for the avatar corresponding to the remote user in the three-dimensional environment 550A includes updating display of the spatial arrangement (e.g., horizontal or vertical spatial arrangement) of the virtual canvases representing the remote users in the multi-user communication session to enable the avatar corresponding to the remote user to be displayed at a location in the three-dimensional environment 550A that is closest to the position of the non-spatial representation of the remote user in the three-dimensional environment 550A (e.g., the position of the virtual canvas 532c within the first row 533a of the horizontal spatial arrangement in the three-dimensional environment 550A). For example, as previously discussed above and as illustrated in the overhead view 510 in FIG. 5J, the (e.g., ideal) placement location that is closest to the position of the virtual canvas 532c within the first row 533a of the horizontal spatial arrangement in the three-dimensional environment 550A corresponds to the location that is currently occupied by the avatar 511 in the three-dimensional environment 550A. In some such examples, because the plurality of virtual canvases 532 representing the plurality of (e.g., non-spatial) remote users in the multi-user communication session is a virtual representation (e.g., a virtual object) within the three-dimensional environment 550A, the location and/or orientation of the plurality of virtual canvases within the three-dimensional environment 550A is able to be freely and easily updated relative to the viewpoint of the first electronic device 101a (e.g., and the viewpoint of the second electronic device 101b). More specifically, in some examples, the plurality of virtual canvases 532 (e.g., within the horizontal spatial arrangement) is able to be repositioned and/or reoriented in the three-dimensional environment 550A (e.g., as a group) from the viewpoint of the first electronic device 101a to accommodate the display of the avatar 513 in the three-dimensional environment 550A (e.g., because the virtual canvases correspond to virtual objects that are generated and displayed by the first electronic device 101a). Accordingly, in some examples, as shown in FIG. 5J, the first electronic device 101a (e.g., and the second electronic device 101b) repositions and/or reorients the plurality of virtual canvases 532 (e.g., as a group) within the horizontal spatial arrangement (e.g., while maintaining the current order and/or spatial distribution of the virtual canvases within the first row 533a and the second row 533b), as shown in the overhead view 510, relative to the viewpoint of the first electronic device 101a, such that the plurality of virtual canvases 532 is now shifted rightward and rotated clockwise (e.g., about a vertical axis through a center of the horizontal spatial arrangement of virtual canvases 532) relative to the viewpoint of the first electronic device 101a (e.g., and the viewpoint of the second electronic device 101b) in the three-dimensional environment 550A, thereby creating an updated identified placement location for the avatar corresponding to the fourth user discussed above that is unoccupied in the three-dimensional environment 550A. For example, as illustrated in the overhead view 510 in FIG. 5J, repositioning and/or reorienting the plurality of virtual canvases 532 (e.g., as a group) in the three-dimensional environment 550A relative to the first electronic device 101a (e.g., and the second electronic device 101b) causes the avatar 511 to no longer be positioned in front of and/or adjacent to the position of the virtual canvas 532c within the first row 533a of the horizontal spatial arrangement in the three-dimensional environment 550A shown in FIG. 5H.

In some examples, as shown in FIG. 5J, following the repositioning and/or reorienting of the plurality of virtual canvases 532 in the three-dimensional environment 550A, the first electronic device 101a (e.g., and the second electronic device 101b) displays avatar 513 corresponding to the fourth user at the updated placement location in the three-dimensional environment 550A, indicating that the fourth user is now participating spatially in the multi-user communication session. For example, as shown in the overhead view 510 in FIG. 5J, the avatar 513 is displayed at a location in the three-dimensional environment 550A corresponding to the updated placement location, which is spatially closest to (e.g., is adjacent to and/or in front of) the position in the first row 533a of the horizontal spatial arrangement that was previously occupied by the virtual canvas 532c in the three-dimensional environment 550A from the viewpoint of the first electronic device 101a. Additionally, in some examples, as indicated in the overhead view 510 in FIG. 5J, the avatar 513 is displayed with an orientation that faces toward the plurality of virtual canvases 532 in the three-dimensional environment 550A, as similarly discussed above. In some examples, as previously described herein and as illustrated in FIG. 5J, when the avatar 513 is displayed in the three-dimensional environment 550A, the first electronic device 101a (e.g., and the second electronic device 101b) updates the order or spatial distribution of the virtual canvases within the horizontal spatial arrangement in the three-dimensional environment 550 based on ceasing display of the virtual canvas 532c corresponding to the fourth user in the three-dimensional environment 550A. For example, as shown in FIG. 5J, after the virtual canvas 532c ceases to be displayed in the three-dimensional environment 550A, the virtual canvas 532e representing a respective remote user is moved and/or transitioned to the position of the virtual canvas 532c within the first row 533a. Particularly, as shown, the virtual canvas 532e is moved from the second row 533b to the first row 533a within the horizontal spatial arrangement in accordance with the updated prioritization order of the virtual canvases that is updated based on the updated prioritization data following the transition of the display of the visual representation of the fourth user from the virtual canvas 532c to the avatar 513 in the three-dimensional environment 550A, as previously described herein.

As an alternative example, in FIG. 5K, determining the alternative placement location for the avatar corresponding to the remote user in the three-dimensional environment 550A includes identifying a next-closest location (e.g., within a threshold distance of, such as 0.25, 0.5, 0.75, 1, 1.5, 2, 3, 5, 10, etc. meters of) in the three-dimensional environment 550A relative to the position of the virtual canvas 532c within the first row 533a of the horizontal spatial arrangement in the three-dimensional environment 550A that is unoccupied. For example, as illustrated in the overhead view 510 in FIG. 5K, the location in the three-dimensional environment 550A that is between the avatar 511 and the first respective user 502 of the first electronic device 101a is not occupied relative to the position of the virtual canvas 532c within the first row 533a, whereas the remaining suitable locations in the three-dimensional environment 550A are occupied (e.g., by the second respective user 504 of the second electronic device 101b and the stand 507). Particularly, the location in the three-dimensional environment 550A that is between the avatar 511 and the first respective user 502 in the three-dimensional environment 550A, as illustrated in the overhead view 510 in FIG. 5K, corresponds to and/or is aligned to a spatial arrangement of the spatial users within the multi-user communication session. For example, in the overhead view 510 in FIG. 5K, the positions of the avatar 511, the first respective user 502, and the second respective user 504 correspond to and/or form an arc relative to the horizontal spatial arrangement of the virtual tiles representing the plurality of remote users in the multi-user communication session. As such, in some examples, the updated (e.g., alternative) placement location for the avatar corresponding to the fourth user discussed above is selected to be an unoccupied location that is within the threshold distance discussed above of the previous position of the virtual canvas 532c in the first row 533a and that is unoccupied in the three-dimensional environment 550A.

In some examples, as shown in FIG. 5K, following the determination of the updated placement location in the three-dimensional environment 550A, the first electronic device 101a (e.g., and the second electronic device 101b) displays avatar 513 corresponding to the fourth user at the updated placement location in the three-dimensional environment 550A, indicating that the fourth user is now participating spatially in the multi-user communication session. For example, as shown in the overhead view 510 in FIG. 5K, the avatar 513 is displayed between the locations of the avatar 511 and the first respective user 502 in the three-dimensional environment 550A from the viewpoint of the first electronic device 101a. Additionally, in some examples, as indicated in FIG. 5K, the avatar 513 is displayed with an orientation that faces toward the plurality of virtual canvases 532 in the three-dimensional environment 550A, as similarly discussed above. In some examples, as previously described herein and as illustrated in FIG. 5K, when the avatar 513 is displayed in the three-dimensional environment 550A, the first electronic device 101a (e.g., and the second electronic device 101b) updates the order or spatial distribution of the virtual canvases within the horizontal spatial arrangement in the three-dimensional environment 550 based on ceasing display of the virtual canvas 532c corresponding to the fourth user in the three-dimensional environment 550A. For example, as shown in FIG. 5K, after the virtual canvas 532c ceases to be displayed in the three-dimensional environment 550A, the virtual canvas 532e representing a respective remote user is moved and/or transitioned to the position of the virtual canvas 532c within the first row 533a. Particularly, the virtual canvas 532e is moved from the second row 533b to the first row 533a within the horizontal spatial arrangement in accordance with the updated prioritization order of the virtual canvases that is updated based on the updated prioritization data following the transition of the display of the virtual canvas 532c to the avatar 513 in the three-dimensional environment 550A, as previously described herein.

Accordingly, as outlined above, providing systems and methods for transitioning display of a visual representation of a remote user from a non-spatial representation to a spatial representation within a multi-user communication session when the remote user requests to participate in the multi-user communication session spatially in a manner that accommodates the locations of virtual and physical objects and users in a three-dimensional environment enables the remote user to participate spatially in the multi-user communication session while acquiescing to the existing spatial arrangement of the virtual and physical objects and users, which enhances the user experience within the multi-user communication session. Additionally, automatically determining an updated placement location at which to display the spatial representation of the remote user in a three-dimensional environment and/or automatically updating display of representations of remote users in the three-dimensional environment based on the prior location of the non-spatial representation of the remote user in the three-dimensional environment reduces the need for user input for manually selecting the placement location and/or for updating display of the representations of the remote users, which helps reduce consumption of computing resources associated with responding to such user input, as another benefit.

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of user interfaces (e.g., virtual objects 330, 420, 430, and 520) may be provided in an alternative shape than a rectangular shape, such as a circular shape, triangular shape, etc. In some examples, the various selectable options (e.g., pill 422/522, representations 431a-431f, and/or selectable option 524), user interface elements (e.g., grabber bar 437/537), etc. described herein may be selected verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

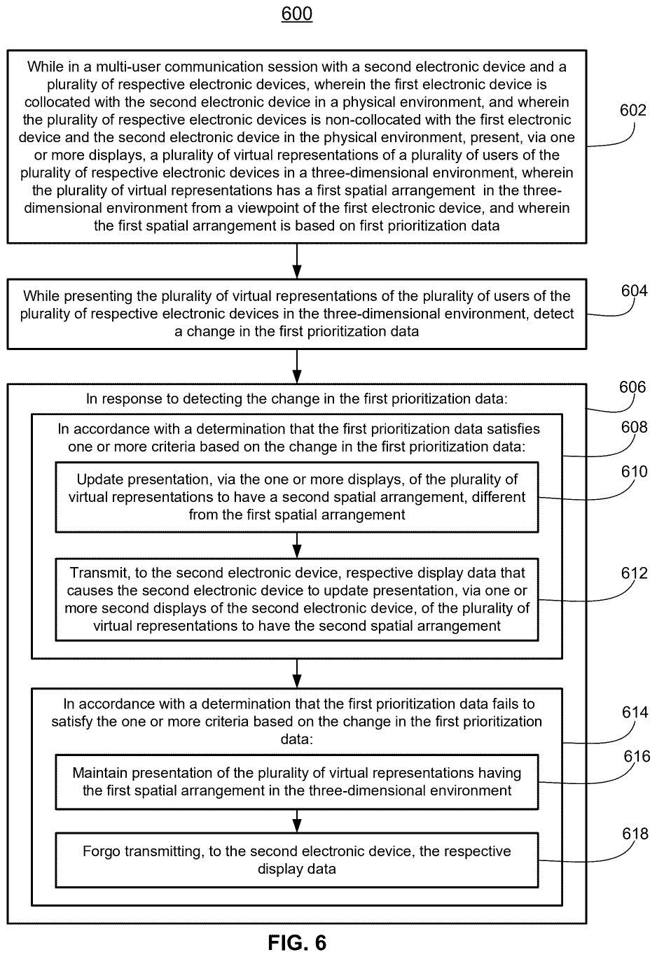

FIG. 6 is a flow diagram illustrating an example process for maintaining visual consistency of a visual representation of a remote user in a three-dimensional environment within a multi-user communication session according to some examples of the disclosure. In some examples, process 600 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 6, in some examples, at 702, while in a multi-user communication session with the second electronic device and a plurality of respective electronic devices, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data. For example, as shown in FIG. 4C, while first electronic device 101a is in a multi-user communication session with a plurality of electronic devices, including second electronic device 101b, the first electronic device 101a is presenting three-dimensional environment 450A that includes a plurality of virtual canvases 432 corresponding to a plurality of users of a plurality of electronic devices that is non-collocated with the first electronic device 101a and the second electronic device 101b in physical environment 400. Additionally, in some examples, as shown in FIG. 4C, the plurality of virtual canvases 432 is arranged within a horizontal spatial arrangement in the three-dimensional environment 450A including two rows 433a and 433b of virtual canvases, where the virtual canvases have a particular order or spatial distribution within the two rows 433a and 433b that is based on the prioritization data.

In some examples, at 604, while presenting the plurality of virtual representations of the plurality of users of the plurality of respective electronic devices in the three-dimensional environment, the first electronic device detects a change in the first prioritization data. For example, as described with reference to FIG. 4C, the first electronic device 101a detects an indication or user input that causes the prioritization data the controls the prioritization order of the virtual canvases 432a-432f to change, such as a change in user activity (e.g., video and/or audio activity) of one or more remote users in the multi-user communication session.

In some examples, at 606, in response to detecting the change in the first prioritization data, at 608, in accordance with a determination that the first prioritization data satisfies one or more criteria based on the change in the first prioritization data, at 610, the first electronic device updates presentation, via the one or more displays, of the plurality of virtual representations to have a second spatial arrangement, different from the first spatial arrangement, and at 612, transmits, to the second electronic device, respective display data that causes the second electronic device to update presentation, via one or more second displays of the second electronic device, of the plurality of virtual representations to have the second spatial arrangement. For example, as described with reference to FIG. 4E, the one or more criteria include a criterion that is satisfied when the change in the prioritization data causes the prioritization order of the virtual canvases 432a-432f to change, such that a virtual canvas in the second row 433b (e.g., the virtual canvas 432e) is moved to the first row 433a of the horizontal spatial arrangement of virtual canvases in the three-dimensional environment 450A. Accordingly, in some examples, as shown in FIG. 4E, the first electronic device 101a updates display of the order or spatial distribution of the virtual canvases 432a-432f within the horizontal spatial arrangement of virtual canvases in the three-dimensional environment 450A, including moving the virtual canvas 432e from the second row 433b to the first row 433a in the three-dimensional environment 450A. In some examples, as described with reference to FIG. 4E, the first electronic device 101a transmits a signal or data (e.g., including instructions) to the second electronic device 101b indicating the prioritization data associated with the order or spatial distribution of the virtual canvases 432a-432f, which causes the second electronic device 101b to update the order or spatial distribution of the virtual canvases 432a-432f in the three-dimensional environment 450B, including moving the virtual canvas 432e from the second row 433b to the first row 433a in the three-dimensional environment 450B.

In some examples, at 614, in accordance with a determination that the first prioritization data fails to satisfy the one or more criteria based on the change in the first prioritization data, at 616, the first electronic device maintains presentation of the plurality of virtual representations having the first spatial arrangement in the three-dimensional environment, and at 618, forgoes transmitting, to the second electronic device, the respective display data. For example, as similarly described with reference to FIG. 4E, the first electronic device 101a maintains display of the order or spatial distribution of the virtual canvases 432a-432f in the three-dimensional environment 450A and forgoes transmitting the signal or data to the second electronic device 101b indicating the updating of the prioritization data associated with the order or spatial distribution of the virtual canvases 432a-432f.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

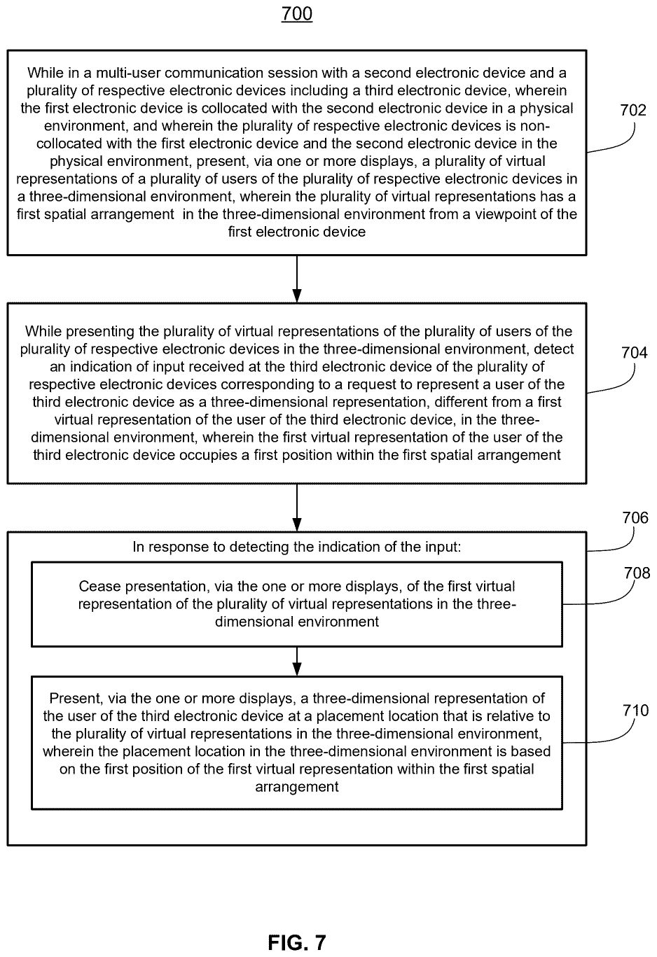

FIG. 7 is a flow diagram illustrating an example process for transitioning display of a visual representation of a remote user from a virtual canvas to a three-dimensional avatar in a three-dimensional environment within a multi-user communication session according to some examples of the disclosure. In some examples, process 700 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 7, in some examples, at 702, while in a multi-user communication session with the second electronic device and a plurality of respective electronic devices including a third electronic device, wherein the plurality of respective electronic devices is non-collocated with the first electronic device and the second electronic device in the physical environment, the first electronic device presents, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device. For example, as shown in FIG. 5A, while first electronic device 101a is in a multi-user communication session with a plurality of electronic devices, including second electronic device 101b, the first electronic device 101a is presenting three-dimensional environment 550A that includes a plurality of virtual canvases 532 corresponding to a plurality of users of a plurality of electronic devices that is non-collocated with the first electronic device 101a and the second electronic device 101b in physical environment 500. Additionally, in some examples, as shown in FIG. 5A, the plurality of virtual canvases 532 is arranged within a horizontal spatial arrangement in the three-dimensional environment 550A including two rows 533a and 533b of virtual canvases, where the virtual canvases have a particular order or spatial distribution within the two rows 533a and 533b.

In some examples, at 704, while presenting the plurality of virtual representations of the plurality of users of the plurality of respective electronic devices in the three-dimensional environment, the first electronic device detects an indication of input received at the third electronic device of the plurality of respective electronic devices corresponding to a request to represent a user of the third electronic device as a three-dimensional representation, different from a first virtual representation of the user of the third electronic device, in the three-dimensional environment, wherein the first virtual representation of the user of the third electronic device occupies a first position within the first spatial arrangement. For example, as shown in FIG. 5B, third electronic device 101c that is in the multi-user communication session with the first electronic device 101a and the second electronic device 101b detects a selection provided by hand 505 of third respective user 506 of selectable option 524 for transitioning a spatial state of the third respective user 506 of the third electronic device 101c from being non-spatial to spatial within the multi-user communication session. Additionally, in some examples, as shown in FIG. 5A, while the third respective user 506 is associated with the non-spatial state in the multi-user communication session (e.g., prior to the third electronic device 101c detecting the selection of the selectable option 524), virtual canvas 532b representing the third respective user 506 is displayed at a leftmost position in the first row 533a of the horizontal spatial arrangement of virtual canvases in the three-dimensional environment 550A from the viewpoint of the first electronic device 101a.

In some examples, at 706, in response to detecting the indication of the input, the first electronic device, at 708, ceases presentation, via the one or more displays, of the first virtual representation of the plurality of virtual representations in the three-dimensional environment, and at 710, presents, via the one or more displays, a three-dimensional representation of the user of the third electronic device at a placement location that is relative to the plurality of virtual representations in the three-dimensional environment, wherein the placement location in the three-dimensional environment is based on the first position of the first virtual representation within the first spatial arrangement. For example, as described with reference to FIG. 5B and as shown in FIG. 5C, the first electronic device 101a ceases display of the virtual canvas 532b representing the third respective user 506 within the first row 533a of the horizontal spatial arrangement of virtual canvases, and displays avatar 511 corresponding to the third respective user 506 in the three-dimensional environment 550A. Additionally, in some examples, as described with reference to FIG. 5C, a location at which the avatar 511 is displayed in the three-dimensional environment 550A is based on (e.g., is spatially closest to) the prior position of the virtual canvas 432b within the first row 533a of the horizontal spatial arrangement of virtual canvases (e.g., prior to the virtual canvas 532b no longer being displayed) in the three-dimensional environment 550A.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices, wherein the first electronic device is collocated with a second electronic device in a physical environment: while in a multi-user communication session with the second electronic device and a plurality of respective electronic devices, wherein the plurality of respective electronic devices is non-collocated with the first electronic device and the second electronic device in the physical environment, presenting, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data; while presenting the plurality of virtual representations of the plurality of users of the plurality of respective electronic devices in the three-dimensional environment, detecting a change in the first prioritization data; and in response to detecting the change in the first prioritization data, in accordance with a determination that the first prioritization data satisfies one or more criteria based on the change in the first prioritization data: updating presentation, via the one or more displays, of the plurality of virtual representations to have a second spatial arrangement, different from the first spatial arrangement; and transmitting, to the second electronic device, respective display data that causes the second electronic device to update presentation, via one or more second displays of the second electronic device, of the plurality of virtual representations to have the second spatial arrangement; and in accordance with a determination that the first prioritization data fails to satisfy the one or more criteria based on the change in the first prioritization data: maintaining presentation of the plurality of virtual representations having the first spatial arrangement in the three-dimensional environment; and forgoing transmitting, to the second electronic device, the respective display data.

Additionally or alternatively, in some examples, the three-dimensional environment includes a shared application window, and presenting the plurality of virtual representations of the plurality of users in the first spatial arrangement includes presenting the plurality of virtual representations relative to the shared application window in the three-dimensional environment. Additionally or alternatively, in some examples, presenting the plurality of virtual representations relative to the shared application window includes presenting the plurality of virtual representations within a column of virtual representations adjacent to the shared application window from the viewpoint of the first electronic device in the three-dimensional environment. Additionally or alternatively, in some examples, the three-dimensional environment does not include a shared application window, and presenting the plurality of virtual representations of the plurality of users in the first spatial arrangement includes presenting the plurality of virtual representations within a virtual object in the three-dimensional environment. Additionally or alternatively, in some examples, presenting the plurality of virtual representations within the virtual object includes presenting the plurality of virtual representations in a plurality of rows within the virtual object in the three-dimensional environment. Additionally or alternatively, in some examples, a first subset of users of the plurality of users is associated with one or more first prioritization values within the first prioritization data, and first one or more virtual representations of the first subset of users are presented in a first row of the plurality of rows within the virtual object, and a second subset, different from the first subset, of users of the plurality of users is associated with one or more second prioritization values, different from the one or more first prioritization values, within the first prioritization data, and second one or more virtual representations of the second subset of users are presented in a second row, below the first row, of the plurality of rows within the virtual object.

Additionally or alternatively, in some examples, the first one or more virtual representations are presented at a first size within the first row from the viewpoint of the first electronic device, and the second one or more virtual representations are presented at a second size, smaller than the first size, within the second row from the viewpoint of the user. Additionally or alternatively, in some examples, the one or more criteria include a criterion that is satisfied based on the change in the first prioritization data when a respective user of the plurality of users associated with the one or more second prioritization values becomes associated with the one or more first prioritization values, and updating presentation of the plurality of virtual representations to have the second spatial arrangement includes moving a respective virtual representation of the respective user from the second row in the virtual object to the first row in the virtual object. Additionally or alternatively, in some examples, when the change in the first prioritization data is detected at the first electronic device, the second electronic device is presenting, via the one or more second displays, the plurality of virtual representations in the first spatial arrangement in a second three-dimensional environment based on second prioritization data having one or more characteristics of the first prioritization data. Additionally or alternatively, in some examples, updating presentation of the plurality of virtual representations to have the second spatial arrangement is further based on detecting, via the one or more input devices, an input directed to one or more of the plurality of virtual representations in the three-dimensional environment provided by the user of the first electronic device. Additionally or alternatively, in some examples, the plurality of virtual representations of the plurality of users includes a first virtual representation of a first respective user of a third electronic device and a second virtual representation of a second respective user of a fourth electronic device, different from the third electronic device, and the first virtual representation of the first respective user occupies a first position within the first spatial arrangement and the second virtual representation of the second respective user occupies a second position, different from the first position, within the first spatial arrangement based on the first prioritization data. Additionally or alternatively, in some examples, the first respective user is associated with a first prioritization value of the first prioritization data and the second respective user is associated with a second prioritization value, different from the first prioritization value, of the first prioritization data, in accordance with a determination that the first prioritization value corresponds to a higher priority than the second prioritization value, the first position of the first virtual representation is prioritized relative to the second position of the second virtual representation within the first spatial arrangement, and in accordance with a determination that the second prioritization value corresponds to a higher priority than the first prioritization value, the second position of the second virtual representation is prioritized relative to the first position of the first virtual representation within the first spatial arrangement.

Additionally or alternatively, in some examples, the first prioritization data is based on input data corresponding to user input provided by the plurality of users that is detected by the plurality of respective electronic devices. Additionally or alternatively, in some examples, detecting the change in the first prioritization data includes detecting a change in the input data that indicates one or more of the plurality of respective electronic devices has detected user input activity. Additionally or alternatively, in some examples, the one or more criteria include a criterion that is satisfied based on the change in the first prioritization data when the user input activity detected by one of the plurality of respective electronic devices exceeds the user input activity detected by others of the plurality of respective electronic devices. Additionally or alternatively, in some examples, the one or more criteria include a criterion that is satisfied based on the change in the first prioritization data when a first respective electronic device of the plurality of respective electronic devices has detected user input provided by a first respective user of the first respective electronic device corresponding to a request to represent the first respective user of the first respective electronic device as a three-dimensional representation in the three-dimensional environment that causes a first virtual representation of the first respective user to cease being presented within the first spatial arrangement in the three-dimensional environment. Additionally or alternatively, in some examples, the plurality of virtual representations includes one or more virtual representations of one or more respective users who have been invited to join the multi-user communication session, but have not yet joined the multi-user communication session. Additionally or alternatively, in some examples, the first prioritization data causes the one or more virtual representations to occupy one or more least prioritized positions within the first spatial arrangement in the three-dimensional environment. Additionally or alternatively, in some examples, the method further comprises: while in the multi-user communication session with the second electronic device and the plurality of respective electronic devices, and while presenting the plurality of virtual representations of the plurality of users in the second spatial arrangement in the three-dimensional environment from the viewpoint of the first electronic device, and wherein the first spatial arrangement is based on first prioritization data, detecting a second change in the first prioritization data; and in response to detecting the second change in the first prioritization data: in accordance with a determination that the first prioritization data satisfies the one or more criteria based on the second change in the first prioritization data, updating presentation, via the one or more displays, of the plurality of virtual representations to have a third spatial arrangement, different from the second spatial arrangement, and transmitting, to the second electronic device, second respective display data that causes the second electronic device to update presentation, via one or more second displays of the second electronic device, of the plurality of virtual representations to have the third spatial arrangement; and in accordance with a determination that the first prioritization data fails to satisfy the one or more criteria based on the second change in the first prioritization data, maintaining presentation of the plurality of virtual representations having the second spatial arrangement in the three-dimensional environment, and forgoing transmitting, to the second electronic device, the second respective display data. Additionally or alternatively, in some examples, the first electronic device, the second electronic device, and the plurality of respective electronic devices each include a head-mounted display.

Some examples of the disclosure are directed to a method comprising, at a first electronic device in communication with one or more displays and one or more input devices, wherein the first electronic device is collocated with a second electronic device in a physical environment: while in a multi-user communication session with the second electronic device and a plurality of respective electronic devices including a third electronic device, wherein the plurality of respective electronic devices is non-collocated with the first electronic device and the second electronic device in the physical environment, presenting, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device; while presenting the plurality of virtual representations of the plurality of users of the plurality of respective electronic devices in the three-dimensional environment, detecting an indication of input received at the third electronic device of the plurality of respective electronic devices corresponding to a request to represent a user of the third electronic device as a three-dimensional representation, different from a first virtual representation of the user of the third electronic device, in the three-dimensional environment, wherein the first virtual representation of the user of the third electronic device occupies a first position within the first spatial arrangement; and in response to detecting the indication of the input: ceasing presentation, via the one or more displays, of the first virtual representation of the plurality of virtual representations in the three-dimensional environment; and presenting, via the one or more displays, a three-dimensional representation of the user of the third electronic device at a placement location that is relative to the plurality of virtual representations in the three-dimensional environment, wherein the placement location in the three-dimensional environment is based on the first position of the first virtual representation within the first spatial arrangement.

Additionally or alternatively, in some examples, the three-dimensional environment includes a shared application window, and presenting the plurality of virtual representations of the plurality of users in the first spatial arrangement includes presenting the plurality of virtual representations relative to the shared application window in the three-dimensional environment. Additionally or alternatively, in some examples, presenting the plurality of virtual representations relative to the shared application window includes presenting the plurality of virtual representations within a column of virtual representations adjacent to the shared application window from the viewpoint of the first electronic device in the three-dimensional environment. Additionally or alternatively, in some examples, the first position within the first spatial arrangement corresponds to a first location within the column of the virtual representations in the three-dimensional environment from the viewpoint of the first electronic device. Additionally or alternatively, in some examples, the three-dimensional environment does not include a shared application window, and presenting the plurality of virtual representations of the plurality of users in the first spatial arrangement includes presenting the plurality of virtual representations within a virtual object in the three-dimensional environment. Additionally or alternatively, in some examples, presenting the plurality of virtual representations within the virtual object includes presenting the plurality of virtual representations in a plurality of rows within the virtual object in the three-dimensional environment. Additionally or alternatively, in some examples, the first position within the first spatial arrangement corresponds to a first location within a first row of the plurality of rows within the virtual object. Additionally or alternatively, in some examples, the placement location in the three-dimensional environment corresponds to a respective location in the three-dimensional environment that is within a threshold distance of the first position within the first spatial arrangement from the viewpoint of the first electronic device.

Additionally or alternatively, in some examples, in accordance with a determination that the respective location in the three-dimensional environment that is within the threshold distance of the first position is occupied by a respective user of a respective electronic device, different from the third electronic device, in the multi-user communication session, the placement location in the three-dimensional environment corresponds to a second respective location, different from the respective location, that is within the threshold distance of the first position. Additionally or alternatively, in some examples, presenting the three-dimensional representation of the user of the third electronic device at the placement location in the three-dimensional environment includes, in accordance with a determination that the respective location in the three-dimensional environment that is within the threshold distance of the first position is occupied by a second three-dimensional representation of a respective user of a respective electronic device of the plurality of respective electronic devices, different from the third electronic device, updating presentation of the second three-dimensional representation of the respective user to no longer occupy the respective location in the three-dimensional environment from the viewpoint of the first electronic device. Additionally or alternatively, in some examples, presenting the three-dimensional representation of the user of the third electronic device at the placement location in the three-dimensional environment includes, in accordance with a determination that the respective location in the three-dimensional environment that is within the threshold distance of the first position is occupied by a second three-dimensional representation of a respective user of a respective electronic device of the plurality of respective electronic devices, different from the third electronic device: moving the plurality of virtual representations in the three-dimensional environment to generate a second respective location in the three-dimensional environment that is within the threshold distance of the first position within the first spatial arrangement form the viewpoint of the first electronic device; and presenting the three-dimensional representation of the user of the third electronic device at the second respective location in the three-dimensional environment. Additionally or alternatively, in some examples, when the indication of input received at the third electronic device of the plurality of respective electronic devices corresponding to the request to represent the user of the third electronic device as a three-dimensional representation in the three-dimensional environment is detected at the first electronic device, the second electronic device is presenting, via one or more second displays of the second electronic device, the plurality of virtual representations in the first spatial arrangement in a second three-dimensional environment.

Additionally or alternatively, in some examples, when the three-dimensional representation of the user of the third electronic device is presented at the placement location in the three-dimensional environment at the first electronic device in response to detecting the indication, the second electronic device presents, via the one or more second displays, the three-dimensional representation of the user of the third electronic device at the placement location that is relative to the plurality of virtual representations in the second three-dimensional environment. Additionally or alternatively, in some examples, the plurality of virtual representations includes a second virtual representation of a user of a fourth electronic device, different from the third electronic device. In some examples, the method further comprises, in response to detecting the indication of the input, after ceasing presentation of the first virtual representation of the plurality of virtual representations in the three-dimensional environment, moving the second virtual representation of the user of the fourth electronic device to the first position within the first spatial arrangement in the three-dimensional environment. Additionally or alternatively, in some examples, the method further comprises: while in the multi-user communication session with the second electronic device and the plurality of respective electronic devices including the third electronic device, and while presenting the plurality of virtual representations of the plurality of users and the three-dimensional representation of the user of the third electronic device in the three-dimensional environment, detecting a second indication of input received at a fourth electronic device, different from the third electronic device, of the plurality of respective electronic devices corresponding to a request to represent a user of the fourth electronic device as a three-dimensional representation, different from a second virtual representation of the user of the fourth electronic device, in the three-dimensional environment, wherein the second virtual representation of the user of the fourth electronic device occupies a second position within the first spatial arrangement; and in response to detecting the second indication of the input, ceasing presentation, via the one or more displays, of the second virtual representation of the plurality of virtual representations in the three-dimensional environment, and presenting, via the one or more displays, a three-dimensional representation of the user of the fourth electronic device at a second placement location, different from the placement location, that is relative to the plurality of virtual representations in the three-dimensional environment, wherein the second placement location in the three-dimensional environment is based on the second position of the second virtual representation within the first spatial arrangement. Additionally or alternatively, in some examples, the first electronic device, the second electronic device, and the plurality of respective electronic devices, including the third electronic device, each include a head-mounted display.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device in a physical environment:
while in a multi-user communication session with the second electronic device and a plurality of respective electronic devices, wherein the plurality of respective electronic devices is non-collocated with the first electronic device and the second electronic device in the physical environment, presenting, via the one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data;
while presenting the plurality of virtual representations of the plurality of users of the plurality of respective electronic devices in the three-dimensional environment, detecting a change in the first prioritization data; and
in response to detecting the change in the first prioritization data:
in accordance with a determination that the first prioritization data satisfies one or more criteria based on the change in the first prioritization data:
updating presentation, via the one or more displays, of the plurality of virtual representations to have a second spatial arrangement, different from the first spatial arrangement; and
transmitting, to the second electronic device, respective display data that causes the second electronic device to update presentation, via one or more second displays of the second electronic device, of the plurality of virtual representations to have the second spatial arrangement; and
in accordance with a determination that the first prioritization data fails to satisfy the one or more criteria based on the change in the first prioritization data:
maintaining presentation of the plurality of virtual representations having the first spatial arrangement in the three-dimensional environment; and
forgoing transmitting, to the second electronic device, the respective display data.

2. The method of claim 1, wherein:
the three-dimensional environment includes a shared application window; and
presenting the plurality of virtual representations of the plurality of users in the first spatial arrangement includes presenting the plurality of virtual representations relative to the shared application window in the three-dimensional environment.

3. The method of claim 1, wherein:
the three-dimensional environment does not include a shared application window; and
presenting the plurality of virtual representations of the plurality of users in the first spatial arrangement includes presenting the plurality of virtual representations within a virtual object in the three-dimensional environment.

4. The method of claim 1, wherein, when the change in the first prioritization data is detected at the first electronic device, the second electronic device is presenting, via the one or more second displays, the plurality of virtual representations in the first spatial arrangement in a second three-dimensional environment based on second prioritization data having one or more characteristics of the first prioritization data.

5. The method of claim 1, wherein:
the plurality of virtual representations of the plurality of users includes a first virtual representation of a first respective user of a third electronic device and a second virtual representation of a second respective user of a fourth electronic device, different from the third electronic device; and
the first virtual representation of the first respective user occupies a first position within the first spatial arrangement and the second virtual representation of the second respective user occupies a second position, different from the first position, within the first spatial arrangement based on the first prioritization data.

6. The method of claim 5, wherein:
the first respective user is associated with a first prioritization value of the first prioritization data and the second respective user is associated with a second prioritization value, different from the first prioritization value, of the first prioritization data;
in accordance with a determination that the first prioritization value corresponds to a higher priority than the second prioritization value, the first position of the first virtual representation is prioritized relative to the second position of the second virtual representation within the first spatial arrangement; and
in accordance with a determination that the second prioritization value corresponds to a higher priority than the first prioritization value, the second position of the second virtual representation is prioritized relative to the first position of the first virtual representation within the first spatial arrangement.

7. The method of claim 1, wherein the one or more criteria include a criterion that is satisfied based on the change in the first prioritization data when a first respective electronic device of the plurality of respective electronic devices has detected user input provided by a first respective user of the first respective electronic device corresponding to a request to represent the first respective user of the first respective electronic device as a three-dimensional representation in the three-dimensional environment that causes a first virtual representation of the first respective user to cease being presented within the first spatial arrangement in the three-dimensional environment.

8. The method of claim 1, wherein the plurality of virtual representations includes one or more virtual representations of one or more respective users who have been invited to join the multi-user communication session, but have not yet joined the multi-user communication session.

9. A first electronic device comprising:
one or more processors;
memory; and
one or more programs stored in the memory and configured to be executed by the one or more processors, the one or more programs including instructions for performing a method comprising:
while in a multi-user communication session with a second electronic device and a plurality of respective electronic devices, wherein the first electronic device is collocated with the second electronic device in a physical environment and the plurality of respective electronic devices is non-collocated with the first electronic device and the second electronic device in the physical environment, presenting, via one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data;
while presenting the plurality of virtual representations of the plurality of users of the plurality of respective electronic devices in the three-dimensional environment, detecting a change in the first prioritization data; and
in response to detecting the change in the first prioritization data:
in accordance with a determination that the first prioritization data satisfies one or more criteria based on the change in the first prioritization data:
updating presentation, via the one or more displays, of the plurality of virtual representations to have a second spatial arrangement, different from the first spatial arrangement; and
transmitting, to the second electronic device, respective display data that causes the second electronic device to update presentation, via one or more second displays of the second electronic device, of the plurality of virtual representations to have the second spatial arrangement; and
in accordance with a determination that the first prioritization data fails to satisfy the one or more criteria based on the change in the first prioritization data:
maintaining presentation of the plurality of virtual representations having the first spatial arrangement in the three-dimensional environment; and
forgoing transmitting, to the second electronic device, the respective display data.

10. The first electronic device of claim 9, wherein:
the three-dimensional environment includes a shared application window; and
presenting the plurality of virtual representations of the plurality of users in the first spatial arrangement includes presenting the plurality of virtual representations relative to the shared application window in the three-dimensional environment.

11. The first electronic device of claim 9, wherein:
the three-dimensional environment does not include a shared application window; and
presenting the plurality of virtual representations of the plurality of users in the first spatial arrangement includes presenting the plurality of virtual representations within a virtual object in the three-dimensional environment.

12. The first electronic device of claim 9, wherein, when the change in the first prioritization data is detected at the first electronic device, the second electronic device is presenting, via the one or more second displays, the plurality of virtual representations in the first spatial arrangement in a second three-dimensional environment based on second prioritization data having one or more characteristics of the first prioritization data.

13. The first electronic device of claim 9, wherein:
the plurality of virtual representations of the plurality of users includes a first virtual representation of a first respective user of a third electronic device and a second virtual representation of a second respective user of a fourth electronic device, different from the third electronic device; and
the first virtual representation of the first respective user occupies a first position within the first spatial arrangement and the second virtual representation of the second respective user occupies a second position, different from the first position, within the first spatial arrangement based on the first prioritization data.

14. The first electronic device of claim 13, wherein:
the first respective user is associated with a first prioritization value of the first prioritization data and the second respective user is associated with a second prioritization value, different from the first prioritization value, of the first prioritization data;
in accordance with a determination that the first prioritization value corresponds to a higher priority than the second prioritization value, the first position of the first virtual representation is prioritized relative to the second position of the second virtual representation within the first spatial arrangement; and
in accordance with a determination that the second prioritization value corresponds to a higher priority than the first prioritization value, the second position of the second virtual representation is prioritized relative to the first position of the first virtual representation within the first spatial arrangement.

15. The first electronic device of claim 9, wherein the one or more criteria include a criterion that is satisfied based on the change in the first prioritization data when a first respective electronic device of the plurality of respective electronic devices has detected user input provided by a first respective user of the first respective electronic device corresponding to a request to represent the first respective user of the first respective electronic device as a three-dimensional representation in the three-dimensional environment that causes a first virtual representation of the first respective user to cease being presented within the first spatial arrangement in the three-dimensional environment.

16. The first electronic device of claim 9, wherein the plurality of virtual representations includes one or more virtual representations of one or more respective users who have been invited to join the multi-user communication session, but have not yet joined the multi-user communication session.

17. A non-transitory computer readable storage medium storing one or more programs, the one or more programs comprising instructions, which when executed by one or more processors of a first electronic device, cause the first electronic device to perform a method comprising:
while in a multi-user communication session with a second electronic device and a plurality of respective electronic devices, wherein the first electronic device is collocated with the second electronic device in a physical environment and the plurality of respective electronic devices is non-collocated with the first electronic device and the second electronic device in the physical environment, presenting, via one or more displays, a plurality of virtual representations of a plurality of users of the plurality of respective electronic devices in a three-dimensional environment, wherein the plurality of virtual representations has a first spatial arrangement in the three-dimensional environment from a viewpoint of the first electronic device, and wherein the first spatial arrangement is based on first prioritization data;
while presenting the plurality of virtual representations of the plurality of users of the plurality of respective electronic devices in the three-dimensional environment, detecting a change in the first prioritization data; and
in response to detecting the change in the first prioritization data:
in accordance with a determination that the first prioritization data satisfies one or more criteria based on the change in the first prioritization data:
updating presentation, via the one or more displays, of the plurality of virtual representations to have a second spatial arrangement, different from the first spatial arrangement; and
transmitting, to the second electronic device, respective display data that causes the second electronic device to update presentation, via one or more second displays of the second electronic device, of the plurality of virtual representations to have the second spatial arrangement; and
in accordance with a determination that the first prioritization data fails to satisfy the one or more criteria based on the change in the first prioritization data:
maintaining presentation of the plurality of virtual representations having the first spatial arrangement in the three-dimensional environment; and
forgoing transmitting, to the second electronic device, the respective display data.

18. The non-transitory computer readable storage medium of claim 17, wherein:
the three-dimensional environment includes a shared application window; and
presenting the plurality of virtual representations of the plurality of users in the first spatial arrangement includes presenting the plurality of virtual representations relative to the shared application window in the three-dimensional environment.

19. The non-transitory computer readable storage medium of claim 17, wherein:
the three-dimensional environment does not include a shared application window; and
presenting the plurality of virtual representations of the plurality of users in the first spatial arrangement includes presenting the plurality of virtual representations within a virtual object in the three-dimensional environment.

20. The non-transitory computer readable storage medium of claim 17, wherein, when the change in the first prioritization data is detected at the first electronic device, the second electronic device is presenting, via the one or more second displays, the plurality of virtual representations in the first spatial arrangement in a second three-dimensional environment based on second prioritization data having one or more characteristics of the first prioritization data.

21. The method of claim 17, wherein:
the plurality of virtual representations of the plurality of users includes a first virtual representation of a first respective user of a third electronic device and a second virtual representation of a second respective user of a fourth electronic device, different from the third electronic device; and
the first virtual representation of the first respective user occupies a first position within the first spatial arrangement and the second virtual representation of the second respective user occupies a second position, different from the first position, within the first spatial arrangement based on the first prioritization data.

22. The non-transitory computer readable storage medium of claim 21, wherein:
the first respective user is associated with a first prioritization value of the first prioritization data and the second respective user is associated with a second prioritization value, different from the first prioritization value, of the first prioritization data;
in accordance with a determination that the first prioritization value corresponds to a higher priority than the second prioritization value, the first position of the first virtual representation is prioritized relative to the second position of the second virtual representation within the first spatial arrangement; and
in accordance with a determination that the second prioritization value corresponds to a higher priority than the first prioritization value, the second position of the second virtual representation is prioritized relative to the first position of the first virtual representation within the first spatial arrangement.

23. The non-transitory computer readable storage medium of claim 17, wherein the one or more criteria include a criterion that is satisfied based on the change in the first prioritization data when a first respective electronic device of the plurality of respective electronic devices has detected user input provided by a first respective user of the first respective electronic device corresponding to a request to represent the first respective user of the first respective electronic device as a three-dimensional representation in the three-dimensional environment that causes a first virtual representation of the first respective user to cease being presented within the first spatial arrangement in the three-dimensional environment.

24. The non-transitory computer readable storage medium of claim 17, wherein the plurality of virtual representations includes one or more virtual representations of one or more respective users who have been invited to join the multi-user communication session, but have not yet joined the multi-user communication session.
